(19) United States
(12) Patent Application Publication
(10) Pub. No.: US 2026/0288854 A1
(43) Pub. Date: Sep. 24, 2026

(54) SYSTEM

(71) Applicant: SoftBank Group Corp., Tokyo (JP)

(72) Inventor: Hiroshi SHIBASAKI, Tokyo (JP)

(73) Assignee: SoftBank Group Corp., Tokyo (JP)

(21) Appl. No.: 19/565,678

(22) Filed: Mar. 13, 2026

(30) Foreign Application Priority Data
Mar. 19, 2025 (JP) 2025-045057

(51) Int. Cl. G06F 16/432; G06F 16/41; G06F 16/435

(52) U.S. Cl. CPC G06F 16/434; G06F 16/41; G06F 16/435

(57) ABSTRACT

A system includes a processor that is configured to receive information from a user as input, retrieve past data from a database, analyze the received information and the retrieved past data to extract related information, generate a prompt that instructs a generative AI model to generate a specific response based on a result of the analysis, transmit the prompt to the generative AI model, and receive a response from the generative AI model and present the response to the user.

### CROSS-REFERENCE TO RELATED APPLICATION

This application is based on and claims priority under 35 USC 119 from Japanese Patent Application No. 2025-045057 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In various situations, such as product explanations, medical consultations, legal guidance, financial advice, and customer support, users frequently experience psychological anxiety arising from uncertainty, lack of domain knowledge, difficulty in understanding complex information, or past negative experiences. Conventional information-provision systems and dialogue systems are typically designed to deliver factual answers or simple FAQ-type responses but do not effectively leverage historical interaction data to tailor responses to the psychological state or latent concerns of the individual user. As a result, existing systems often fail to sufficiently reduce user anxiety, and may even increase anxiety if the responses are perceived as generic, insensitive, or disconnected from prior similar cases. Furthermore, conventional systems generally do not integrate past datasets containing similar information, question-and-answer records, and subsequent user reactions in a structured manner to inform the generation of more appropriate responses. Therefore, there is a need for a system that can systematically utilize past data to analyze the relationship between the user's current input and prior similar interactions, and that can generate and present responses, via a generative AI model, which are better suited to alleviating the user's psychological anxiety.

### SUMMARY

In order to solve the above-described problems, a system according to one aspect of the present invention comprises a processor, wherein the processor is configured to receive information from a user as input, retrieve past data from a database, analyze the received information and the retrieved past data to extract related information, generate a prompt that instructs a generative AI model to generate a specific response based on a result of the analysis, transmit the prompt to the generative AI model, and receive a response from the generative AI model and present the response to the user. The processor is further configured such that the generated response contributes to alleviating psychological anxiety of the user, for example by reflecting patterns extracted from past datasets including records of similar information and question-and-answer pairs and subsequent reactions, thereby enabling the system to select or influence response strategies that historically led to reduced user anxiety. In this manner, the system integrates analysis of the user's current input with structured past interaction data and utilizes a generative AI model under the control of a generated prompt, so that the system can provide responses that are not only relevant in content but also effective in mitigating the user's psychological anxiety.

The term “system” refers to an arrangement of one or more hardware and/or software components that cooperate to perform processing, storage, communication, and presentation functions as described herein.

The term “processor” refers to one or more hardware processing units, such as a central processing unit (CPU), a graphics processing unit (GPU), a digital signal processor (DSP), or any other integrated circuit or combination of circuits, that executes instructions to perform the functions described in the present specification and claims.

The term “user” refers to a human individual or an entity operating a terminal or client device that provides information as input to the system and receives responses from the system.

The term “information from a user” refers to any data provided by the user to the system, including but not limited to textual input, voice input converted to text, selection inputs through a graphical user interface, and structured or unstructured data representing questions, requests, or contextual information.

The term “past data” refers to data previously stored in a database, including, but not limited to, historical interaction logs, records of questions and corresponding answers, contextual information associated with such interactions, and records of subsequent user reactions.

The term “database” refers to any data storage system or repository, including relational databases, non-relational databases, file-based storage systems, or combinations thereof, that stores past data accessible by the processor.

The term “analyze” refers to the operation of processing data by the processor using one or more techniques, such as statistical analysis, natural language processing, pattern recognition, similarity calculation, or rule-based evaluation, to derive relationships, features, or conclusions from the data.

The term “related information” refers to information extracted by the processor that has a relationship, such as similarity, relevance, correlation, or contextual association, to the information received from the user and to the past data.

The term “prompt” refers to data generated by the processor and provided as input to the generative AI model, the data specifying instructions, constraints, context, or content that guide the generative AI model in producing a specific response.

The term “generative AI model” refers to a machine-learned model, such as a neural network-based language model or multimodal model, that is configured to generate output data, including text, based on input data and learned parameters.

The term “specific response” refers to output generated by the generative AI model according to the prompt, where the output is intended to address the user's input and is influenced by the analysis of the past data and the user's information.

The term “present the response to the user” refers to the operation of outputting the generated response in a human-perceivable form, including displaying text on a screen, outputting synthesized speech, or transmitting data to a user device for presentation.

The term “psychological anxiety of the user” refers to a mental state of the user characterized by worry, unease, stress, or apprehension related to uncertainty, lack of understanding, or perceived risk in connection with the subject matter of the interaction.

The term “contributes to alleviating psychological anxiety of the user” refers to the characteristic of a generated response that, based on design, historical data, or evaluation criteria, is suitable for reducing, mitigating, or easing the user's psychological anxiety.

The term “dataset” refers to a collection of data organized in a structured or semi-structured form, including multiple records or entries, each of which may contain similar information, question-and-answer pairs, and associated subsequent reactions.

The term “records of similar information and question-and-answer pairs and subsequent reactions” refers to entries in the dataset that include user-provided or system-related information similar to the current user input, corresponding questions and answers exchanged in past interactions, and data indicating user reactions following those interactions, such as feedback, behavior logs, or outcome indicators.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

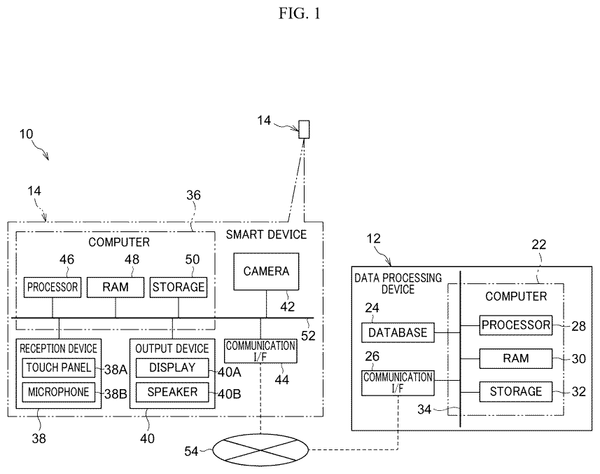

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

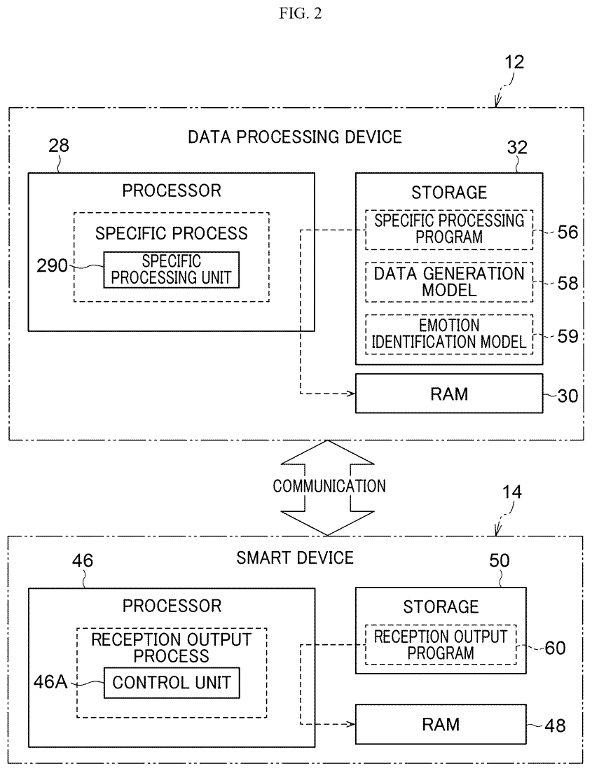

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional presentation-support and content-authoring systems primarily act as passive editors or templates and do not materially improve the functioning of the underlying information processing pipeline. In typical systems, user input, such as presentation materials or scenario descriptions, is handled as flat text and is passed directly to a generative AI model without systematic analysis or integration with structured past case information. As a result, the system is unable to reliably surface contextually relevant examples, cannot efficiently reuse accumulated interaction history, and often produces responses that are generic, poorly targeted, or inconsistent across sessions.

Furthermore, existing systems generally treat past data as static reference content and do not maintain a tightly coupled loop between user inputs, AI prompts, AI responses, and storage of these elements as machine-usable case information. This limits the system's ability to learn from prior interactions at the system level, to build richer case repositories over time, and to refine the prompt construction process in a technically scalable and computationally efficient manner.

In addition, many conventional implementations simply forward the user's free-form query to a generative AI model, which leads to inefficient use of computational resources. The generative AI model is forced to infer context, identify relevant factors, and reconstruct missing background information from limited input, resulting in longer processing, higher token usage, and unstable relevance of the generated content. Consequently, such systems do not provide a technically improved mechanism for selecting and structuring data before invoking expensive generative computations.

There is also a technical deficiency in how existing systems handle similarity computation between current user input and stored cases. In many solutions, similarity is based on keyword matching or simple string comparison, which fails to capture semantic relationships and leads to suboptimal selection of past cases. This degrades the quality of downstream prompt construction and causes the generative AI model to generate responses that do not adequately leverage prior knowledge stored in the system.

Additionally, conventional systems lack mechanisms for systematically decomposing AI outputs into structured units that can be indexed, displayed, and reused as formalized past case information. Without such structuring, it is difficult for the computer system to build an evolving case database that directly feeds back into subsequent similarity searches and prompt generation. This undermines the system's ability to automatically improve relevance and consistency of AI responses over time.

From a user-experience standpoint, existing systems also do not provide a robust technical framework for aligning AI responses with user psychological state, such as presentation anxiety. They lack an integrated process in which prompt sentences and display information are dynamically adjusted, based on both the current input and accumulated past case information, so that the generated responses more effectively reduce user anxiety. This results not only in diminished practical usefulness, but also in underutilization of the computer's capacity to orchestrate data flows, model calls, and response formatting in a technically optimized way.

Accordingly, there is a need for a computer-implemented technique that (i) systematically extracts feature terms and important phrases from input data and past case information using natural language processing, (ii) generates semantic representation vectors and performs similarity-based selection of relevant past cases, (iii) constructs optimized prompt sentences for a generative AI model based on the selected cases and user requests, (iv) structures and stores the generated responses as machine-usable history information, and (v) adjusts prompt sentences and display formats so that the resulting interaction not only improves user support but also enhances the overall efficiency, reliability, and adaptability of the information processing system itself.

The specific processing by the specific processing unit 290 of the data processing device 12 in Example 1 is realized by the following means.

The present invention provides a server comprising a processor configured to receive document information or image information from a user as input data and store the input data in a storage device, to acquire past case information including structured information and unstructured information from an information storage device, to extract character string elements from the input data and the past case information, to perform preprocessing on the character string elements, and to extract feature terms and important phrases by natural language processing, to generate semantic representation vectors for the input data and the past case information, to calculate similarity between the semantic representation vectors, and to select, based on the similarity, past case information related to the input data, to construct a prompt sentence, which is an instruction sentence to a generative AI model, based on the extracted feature terms, the important phrases, summary information of the selected past case information, and a request content supplied by the user, to transmit the constructed prompt sentence to an internal or external generative AI model via a communication network, to obtain response information generated by the generative AI model in response to the prompt sentence and divide or structure the response information into items to generate display information, to output the display information to a display device and present the display information to the user, and to record the input data, the prompt sentence, and the response information as history information and store at least a part of the history information as future past case information. This enables an improved computer-implemented processing pipeline in which input data is semantically analyzed and matched with past cases, optimized prompt sentences are generated and supplied to a generative AI model, AI responses are converted into structured artifacts, and the resulting history is iteratively fed back into similarity search and prompt construction, thereby enhancing the technical performance, efficiency, and adaptability of the overall information processing system.

The term “document information” refers to information expressed in a textual or graphical form and stored as a data object, including but not limited to files, records, or messages that contain characters, symbols, or images interpretable by a computing device.

The term “image information” refers to information representing visual content, including but not limited to bitmap images, vector images, scanned documents, slide screenshots, or other visual data that can be processed by a computing device.

The term “input data” refers to any data received from a user or an external source by a computing device for processing, including document information, image information, and associated metadata or parameters.

The term “storage device” refers to any hardware or virtual component capable of storing data in a non-transitory manner, including but not limited to magnetic storage, optical storage, semiconductor memory, or cloud-based storage resources.

The term “past case information” refers to information representing one or more prior events, examples, interactions, or scenarios, including their descriptions, outcomes, and associated context, which is stored for later retrieval and analysis by a computing device.

The term “structured information” refers to information organized according to a predefined schema or format that allows direct access by field or attribute, including but not limited to tabular records, key-value pairs, or hierarchical data structures.

The term “unstructured information” refers to information that does not conform to a predefined data model, including but not limited to free-text descriptions, narrative documents, emails, or conversational logs, which require parsing or analysis to extract explicit structure.

The term “information storage device” refers to a storage device or combination of storage devices used to store and retrieve past case information, structured information, and unstructured information under control of a processor.

The term “character string elements” refers to units of textual data derived from input data or past case information, including but not limited to characters, tokens, words, phrases, or other segments of text that can be processed by natural language algorithms.

The term “preprocessing” refers to operations performed on raw data before higher-level analysis, including but not limited to normalization, tokenization, noise removal, encoding conversion, and segmentation applied to character string elements.

The term “natural language processing” refers to computational techniques that analyze, interpret, or transform human language data, including but not limited to tokenization, part-of-speech tagging, syntactic parsing, named-entity recognition, and semantic analysis.

The term “feature terms” refers to terms extracted from textual data that represent salient or characteristic concepts for a given context, and that are determined, for example, by frequency measures, statistical weighting, or linguistic criteria.

The term “important phrases” refers to multi-word expressions or sequences of tokens that convey significant semantic meaning within textual data and that are selected based on linguistic, statistical, or contextual measures.

The term “semantic representation vectors” refers to numerical vectors generated from textual or other data that encode semantic information so that similarity or relatedness between different items can be computed by mathematical operations.

The term “similarity” refers to a quantitative measure of relatedness between two or more semantic representation vectors, computed using a mathematical function such as cosine similarity, distance metrics, or correlation measures.

The term “select, based on the similarity” refers to a process in which one or more items, such as past case information, are chosen from a set according to similarity values computed between semantic representation vectors associated with the items and semantic representation vectors associated with input data.

The term “prompt sentence” refers to an instruction sentence or instruction text, provided as input to a generative AI model, that specifies a task, constraints, or context to guide generation of response information.

The term “generative AI model” refers to an information processing model that, upon receiving input data including at least a prompt sentence, generates new data such as text or other content according to learned statistical patterns.

The term “communication network” refers to any wired or wireless communication infrastructure that enables data exchange between computing devices or services, including but not limited to local area networks, wide area networks, and public networks.

The term “response information” refers to data generated by a generative AI model in response to a prompt sentence, including but not limited to textual content, structured recommendations, or explanatory passages.

The term “divide or structure the response information into items” refers to processing in which response information is segmented, grouped, or organized into identifiable units such as sections, bullets, or records suitable for presentation or storage.

The term “display information” refers to information formatted or organized for presentation to a user on a display device, including visual layout, sections, labels, and other elements derived from response information.

The term “display device” refers to any output apparatus capable of visually presenting information to a user, including but not limited to monitors, screens, projection devices, or head-mounted displays.

The term “history information” refers to stored records that capture past interactions or processing results, including at least input data, prompt sentences, response information, and optionally associated metadata, for subsequent retrieval and reuse.

The term “future past case information” refers to history information, or a portion thereof, that is designated and stored for use as past case information in later processing operations.

The term “proposal information” refers to a portion of response information that presents suggested actions, plans, or strategies in connection with input data or a user request.

The term “explanatory information” refers to a portion of response information that explains reasoning, background, or rationale related to proposal information, past case information, or user input.

The term “cautionary information” refers to a portion of response information that indicates risks, warnings, limitations, or points requiring attention in relation to proposal information or a given context.

The term “psychological anxiety” refers to a user's mental state characterized by tension, worry, or unease in relation to a task such as a presentation or communication, which can be influenced by the content and form of system-generated responses.

The term “data set” refers to a collection of data items organized for processing by a computing device, including but not limited to multiple records of explanatory information, question-and-answer information, and reaction information.

The term “explanatory information” (in the context of past cases) refers to descriptive content within past case information that explains circumstances, approaches, or outcomes associated with the past case.

The term “question-and-answer information” refers to information representing exchanged questions and answers in a prior interaction, including queries posed by an inquirer and corresponding responses.

The term “reaction information” refers to information indicating a response, evaluation, or outcome associated with question-and-answer information or explanatory information, such as acceptance, rejection, feedback, or performance indicators.

The term “selection based on the similarity” refers to a computational process in which items within a data set are chosen using similarity values computed between semantic representation vectors associated with those items and semantic representation vectors associated with new input data.

In one embodiment, a server, a terminal, and a communication network cooperate to implement the claimed system. The server comprises at least one processor, a main memory, a non-transitory storage device, and a network interface, and executes software modules that realize the functions described in the claims. The terminal comprises a processor, a memory, a display device, an input device, and a communication interface, and executes an application program or a web browser that communicates with the server.

The server executes an operating system such as a general-purpose server operating system, and runs an application framework implemented, for example, using a scripting language runtime. The server also runs a web server component that terminates HTTP or HTTPS connections from the terminal and forwards requests to an application layer. The storage device of the server includes a file system that stores uploaded files and an information storage device implemented as a relational database management system.

The server uses one or more natural language processing libraries and machine learning libraries, such as a tokenization library, a part-of-speech tagging library, a parsing library, an embedding generation library, and a neural network inference library. The server loads a pre-trained generative AI model, which may be hosted on the same server or on an external server accessible via the communication network. In one embodiment, the generative AI model is a transformer-based neural network including a plurality of encoder-decoder layers, multi-head self-attention units, feed-forward layers, and layer normalization units. The generative AI model is trained on large-scale text corpora using stochastic gradient descent or a variant thereof, with a loss function such as cross-entropy computed between predicted token sequences and ground-truth token sequences. During training, the generative AI model updates its weight parameters by backpropagating gradients through the attention layers and fully connected layers, thereby learning statistical relationships between token sequences.

The server uses an additional embedding model, separate from the generative AI model, to generate semantic representation vectors. In one embodiment, the embedding model is a transformer-based sentence encoder trained using contrastive learning, where pairs of semantically similar text segments are mapped to nearby vectors in an embedding space and dissimilar pairs are mapped to distant vectors. The embedding model uses a vector representation at a designated output layer, such as an average-pooled hidden state or a special classification token state, as the semantic representation vector. The server uses a numerical library to calculate similarity values, such as cosine similarity, between semantic representation vectors representing input data and semantic representation vectors representing past case information.

The server stores past case information in a structured data schema. For example, the server stores each past case as a record comprising fields such as a case identifier, a case title, a short description, a detailed explanation, question-and-answer information, reaction information, tags, and metadata such as timestamps and user identifiers. The server stores the text fields in a text column in the database and optionally stores precomputed semantic representation vectors in a binary column. The server also stores unstructured information, such as raw documents and logs, as files in the file system, with indexes in the database pointing to file locations.

The server uses a data processing pipeline to perform preprocessing and feature extraction. The server normalizes input data and past case information by performing operations such as converting characters to a standard case, removing control characters, standardizing punctuation, and splitting the text into tokens. The server applies a tokenization algorithm, such as a subword tokenization algorithm or a word-based tokenization algorithm, to divide the text into token units. The server applies part-of-speech tagging using a statistical model or a neural model that assigns a grammatical category to each token. The server may apply dependency parsing or constituency parsing to obtain syntactic structure.

The server extracts feature terms and important phrases using a combination of statistical and linguistic methods. The server calculates term frequency and inverse document frequency values for tokens and n-grams across a corpus of past case information and optionally across multiple users'inputs. The server selects feature terms by applying a threshold to the TF-IDF values and by filtering tokens based on part-of-speech tags and a stopword list. The server extracts important phrases by identifying noun phrases, verb-object phrases, or other syntactic patterns from the parsed text. The server may additionally weight feature terms based on their position within a document, their occurrence in titles versus bodies, or their presence in past cases that were previously evaluated as successful.

The server generates semantic representation vectors from the normalized and tokenized text. The server passes sequences of tokens into the embedding model, which applies multi-head attention to compute context-dependent token representations and aggregates these representations into a single vector for each text input. The server stores these semantic representation vectors in memory or in the database. For input data received from the terminal, the server computes a semantic representation vector that summarizes the content of the user's current document information or image-derived textual information. For each past case, the server computes or retrieves a semantic representation vector that summarizes the key content of that case.

The server calculates similarity values between the semantic representation vector of the input data and the semantic representation vectors of the past cases. The server uses cosine similarity, which is computed as the dot product of two vectors divided by the product of their norms, or uses an alternative distance metric such as Euclidean distance. The server ranks the past cases based on these similarity values and selects a subset of past cases that exceed a predetermined similarity threshold or that are within a top-N range. This similarity-based selection allows the server to identify past case information that is semantically related to the user's current input, even when direct keyword matching would fail.

The server generates a prompt sentence for the generative AI model using a rule-based template construction module. The server does not simply forward user input, but instead constructs a structured text that reflects the system's internal analysis. The server includes, in the prompt sentence, a description of the user's task or goal, a list of feature terms and important phrases, and summaries of the selected past cases. The server converts each selected past case into a concise summary using a summarization algorithm, such as an extractive method that selects high-salience sentences based on TF-IDF scores, sentence positions, and embedding-based centrality. The server then concatenates these summaries into a section labeled as past cases in the prompt sentence.

The server also includes the user's explicit request in the prompt sentence, so that the generative AI model can focus on the user's intent. For example, the server constructs prompt sentences such as:

“The user is preparing a presentation for a new B2B product launch. Based on the following past successful cases and the key points in the current slide deck, propose a detailed market entry strategy with concrete action items and risks. Past cases: [summary A, summary B,]. Current deck highlights: [bullets].”

or

“You are a senior consultant specializing in B2B cloud security. The user is preparing a presentation for a new B2B cloud security product launch. Based on the following past successful launches and the key points in the current deck, generate a detailed market entry strategy including positioning, pricing, channels, and risk mitigation. Past cases: [summaries]. Current deck highlights: [bullets]. User request: ‘I want a detailed market entry strategy for our new B2B cloud security product, based on past successful launches.’”

By assembling the prompt sentence in this structured way, the server reduces ambiguity and offloads part of the reasoning steps from the generative AI model to deterministic pre-processing on the server. This has the technical effect of reducing token usage, constraining the search space of the generative AI model, and improving both response time and response relevance.

The server transmits the constructed prompt sentence to the generative AI model via the communication network. The server uses a request format defined by an application programming interface, typically a JSON-based structure, but the core content of the request is the textual prompt sentence. The server sets generation parameters such as maximum token length, temperature, and top-k or nucleus sampling parameters, which affect the diversity and determinism of the generated text. The server may adjust these parameters based on the type of task (for example, strategic planning versus factual explanation) or based on user-defined preferences.

The generative AI model, when executing inference, applies its learned attention weights and feed-forward transformations to iteratively generate an output token sequence conditioned on the prompt sentence. The generative AI model uses internal representations at each layer to compute probability distributions over possible next tokens and selects tokens according to the specified decoding algorithm. Because the prompt sentence already contains semantically relevant past cases and key phrases, the generative AI model can more efficiently focus on fine-grained compositional reasoning instead of reconstructing context from scratch. This division of labor between deterministic pre-processing on the server and probabilistic sequence generation in the model contributes to improved computational efficiency and more stable quality of responses.

The server receives the response information from the generative AI model and divides or structures the response into items. The server parses the generated text by detecting section headers, enumeration markers, bullet symbols, or other typographical cues and converts the unstructured text into a structured representation, such as a list of items, each with a title field and a content field. The server can additionally apply natural language processing again to identify sentences that correspond to proposal information, explanatory information, or cautionary information. For example, the server can apply rule-based detection to identify sentences that include modal verbs such as “should” or phrases like “it is recommended that” as proposal information, and sentences that include words like “because,” “therefore,” or “the reason is” as explanatory information.

The server flags sentences containing terms such as “risk,” “issue,” “problem,” or “caution” as candidate cautionary information. By separating the generated text into these categories, the server enables more precise and usable display to the user and also facilitates storing these segments as distinct fields in the database. This structuring step transforms the raw generative output into machine-usable components that can be re-indexed and reused as part of future past case information.

The server outputs the display information to the terminal using markup or a structured data format that the terminal can render. The terminal displays the response information in a user interface that clearly distinguishes proposal information, explanatory information, and cautionary information, for example, by using different sections or visual indicators. The terminal can also allow the user to select specific items and view linked past cases that were used to generate those items. This linkage provides traceability and allows users to understand how the system formed its recommendations.

The server records each interaction as history information. The server stores the input data, the constructed prompt sentence, the selected past cases, the categorised response information, and metadata such as timestamps and user identifiers in the database. The server designates at least a portion of this history information as future past case information. For example, when a user indicates that a generated strategy was useful, the server may create new case records that summarize the successful recommendations and the context in which they were generated. The server then computes semantic representation vectors for these new cases and adds them to the similarity search index. This continuous enrichment of past case information allows the system to adapt and improve over time, providing better matches for future users.

The server thereby improves computer technology in several ways. First, the use of semantic representation vectors and similarity-based selection allows the server to filter and pre-structure data before invoking the generative AI model. This reduces overall computational load on the generative AI model and network usage, because prompt sentences are more compact and contain only highly relevant information, reducing the amount of extraneous context sent over the communication network. Second, the structured feedback loop, in which AI-generated responses are decomposed into labeled components and stored as future past case information, creates a self-improving data structure that enhances the accuracy and speed of future similarity searches. Third, the rule-based combination of feature terms, important phrases, and past case summaries into prompt sentences enforces a non-conventional pre-processing pipeline that yields more consistent and predictable AI outputs compared to simply forwarding user text.

The system's processing pipeline is not a mere automation of human reasoning. A human operator would not practically compute high-dimensional semantic representation vectors, cosine similarity scores, and dynamic prompt constructions for large corpora of past cases at interactive speeds. The server's use of specialized data structures, such as vector indices, term-frequency maps, and structured case records, combined with algorithmic similarity search and rule-based prompt assembly, constitutes a specific improvement in how computers process and manage text data and interact with generative AI models. This results in faster retrieval, more accurate case matching, reduced error due to irrelevant or noisy context, and lower communication and computation load.

The server can, in some embodiments, coordinate with hardware accelerators such as graphics processing units or tensor processing units to accelerate the embedding generation and inference of the generative AI model. The server dispatches batches of tokenized text to the accelerator, which performs matrix multiplications and attention operations in parallel. This further improves inference speed and enables real-time or near-real-time interactions even when processing large volumes of past case information.

The terminal can be implemented as a personal computer, a tablet, a smartphone, or a dedicated presentation device. The terminal sends presentation materials to the server, displays AI-generated suggestions, and allows the user to modify the presentation content. The user may upload files such as slide documents or text documents through the terminal. The terminal may locally extract text from image information, for example by performing optical character recognition, before sending textual data to the server, or may send raw image data to the server for server-side extraction. In either case, the data structures and algorithms on the server are designed to handle a mixture of document information and image-derived text.

In another embodiment, the server adjusts the prompt sentence and the display information according to detected user anxiety indicators. The server uses sentiment analysis algorithms to analyze user-provided comments or speaker notes and estimates whether the user expresses concern or uncertainty. The server then modifies the prompt sentence by adding instructions such as “include reassuring explanations and step-by-step guidance” and arranges the display information so that key supportive recommendations are shown more prominently. This is not a mere presentation change, because it is implemented through specific computational steps in the prompt construction and response structuring pipeline, which in turn influence how the generative AI model allocates probability mass across different types of content.

Alternative implementations are possible. For example, the server may use different embedding models, such as convolutional neural networks or recurrent neural networks, to generate semantic representation vectors. The server may use different similarity metrics, such as Manhattan distance or learned metric functions. The server may apply clustering algorithms to organize past case information into topic clusters and restrict similarity search to clusters matching certain feature terms. The server may also use different rule sets or templates to construct prompt sentences for different application domains, such as technical documentation, educational content, or customer support scenarios, while maintaining the core structure of including feature terms, important phrases, and selected past case summaries.

In another implementation, the server may be distributed across multiple physical machines, with separate nodes responsible for text preprocessing, vector computation, database access, and generative AI inference. The server uses an internal message queue to pass intermediate results between nodes. This architecture allows the system to scale to large numbers of simultaneous users while maintaining low latency. The same fundamental pipeline semantic analysis, similarity-based selection, structured prompt construction, and structured response storage is preserved across these variations.

Through these concrete mechanisms, the server, the terminal, and the user cooperate within a technically structured framework that is centered on specific data structures, algorithms, and neural network models. The combination yields an improved computer-implemented system for generating, managing, and reusing prompt sentences and generative AI model outputs, resulting in technical effects such as enhanced processing speed, improved accuracy and relevance of generated responses, reduced communication and computation overhead, and more effective long-term data management.

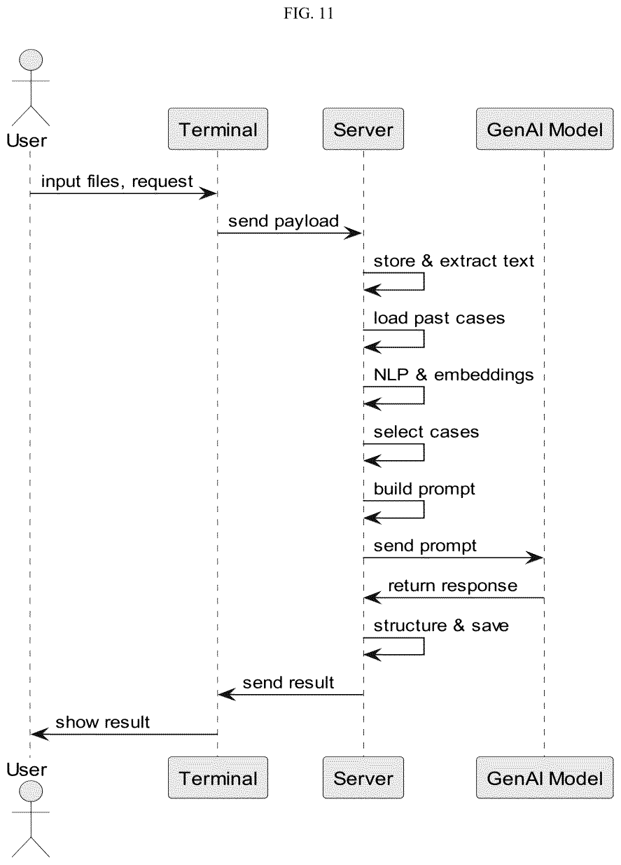

The following describes the processing flow using FIG. 11.

### Step 1

The user operates the terminal to select presentation materials and optional past documents from a local storage device and to input a natural-language request.

The terminal receives, as input, one or more files (such as slide files, text files, or image files) and a text string representing the user's request.

The terminal reads file metadata and user-entered text, packages them into a request message, and outputs a structured payload containing the files, the request text, and optional parameters (such as domain, audience, or language) for transmission to the server.

### Step 2

The terminal transmits the structured payload to the server via a communication network using a request protocol.

The terminal uses the network interface to send, as input to this step, the payload containing the user files, the request text, and parameters.

The terminal encapsulates the payload into a network message, applies encryption where required, and outputs a network-transmittable message addressed to the server's endpoint.

### Step 3

The server receives the network message and stores the raw input data on a storage device.

The server takes, as input, the network message from the terminal and decodes the message to obtain the uploaded files, the request text, and associated metadata.

The server writes the uploaded files to a file system, records references and metadata in a database table, and outputs persistent records that associate a session identifier with file paths, user parameters, and the original request text.

### Step 4

The server extracts textual content from the uploaded files using format-specific extraction routines.

The server receives, as input, the stored file paths and file types associated with the session.

The server applies a dedicated extraction algorithm to each file type, converts binary document formats into plain text, optionally performs optical character recognition on image information to obtain text, and outputs normalized text strings representing the presentation materials and any additional documents.

### Step 5

The server acquires past case information from the information storage device based on predefined selection conditions.

The server uses, as input, configuration parameters, optional user-specified filters, and database schema information describing stored past cases.

The server executes database queries that select records matching criteria such as topic tags, usage domain, or time range, retrieves structured fields (titles, summaries, question-and-answer logs, reaction indicators), and outputs a collection of past case records for further analysis.

### Step 6

The server performs preprocessing on the text of the input data and the past case information to create cleaned token sequences.

The server takes, as input, the normalized text strings derived from the uploaded files and the text fields from the selected past case records.

The server applies operations including lowercasing, removal of control characters, segmentation into tokens, and optional stopword filtering, and outputs tokenized, cleaned text data for each input document and each past case.

### Step 7

The server extracts feature terms and important phrases from the preprocessed text using natural language processing.

The server uses, as input, the tokenized and cleaned text data corresponding to the user's materials and the past case information.

The server computes term statistics, applies part-of-speech tagging and phrase extraction rules, calculates scores such as term frequency-inverse document frequency, selects tokens and phrases exceeding thresholds, and outputs ranked lists of feature terms and important phrases associated with the current session and with individual past cases.

### Step 8

The server generates semantic representation vectors for the input data and the past case information.

The server uses, as input, the preprocessed token sequences or sentence segments for the user's materials and for each past case.

The server passes these inputs through an embedding model to compute numerical vectors in a latent space, aggregates per-sentence or per-paragraph vectors when necessary, and outputs one or more semantic representation vectors for the user's input and for each past case record.

### Step 9

The server calculates similarity values between the semantic representation vectors of the input data and those of the past cases, and selects relevant past cases.

The server receives, as input, the semantic representation vector for the user's current materials and the set of semantic representation vectors for all candidate past cases.

The server applies a similarity function, such as cosine similarity, computes a similarity score for each past case, ranks the past cases according to these scores, filters out cases below a similarity threshold or outside a top-N range, and outputs an ordered subset of past case records deemed relevant to the user's input.

### Step 10

The server summarizes the selected past cases into concise textual descriptions that can be embedded into a prompt sentence.

The server uses, as input, the text fields and metadata of the selected past case records.

The server applies sentence scoring or selection algorithms, such as using term statistics and positional information, selects representative sentences, optionally merges and compresses them, and outputs short summaries for each selected past case.

### Step 11

The server constructs a prompt sentence for the generative AI model based on the feature terms, the important phrases, the summarized past cases, and the user's request.

The server uses, as input, the ranked feature terms, extracted important phrases, the concise summaries for relevant past cases, and the original user request text.

The server inserts these elements into a predefined textual template, arranges sections such as “Context,” “Key concepts,” and “Past cases,” concatenates them into a coherent instruction text, and outputs a complete prompt sentence designed to guide generation by the generative AI model.

### Step 12

The server transmits the constructed prompt sentence and related control parameters to a generative AI model.

The server uses, as input, the prompt sentence and generation parameters such as maximum output length, sampling strategy, and temperature.

The server packages these inputs into a request compatible with the generative AI model's interface, sends the request via the communication network or an internal interface to the model, and outputs a model invocation request awaiting a generated response.

### Step 13

The server obtains response information generated by the generative AI model and converts it into a structured internal representation.

The server receives, as input, the raw textual output or token sequence produced by the generative AI model in response to the prompt sentence.

The server parses the generated text, detects section boundaries and list markers, classifies sentences into categories such as proposal information, explanatory information, and cautionary information according to rule-based or statistical criteria, and outputs a structured data object containing labeled items derived from the generated response.

### Step 14

The server generates display information from the structured response for presentation on the terminal.

The server uses, as input, the structured data object representing the categorized response items.

The server arranges items into a display hierarchy, assigns headings and labels, converts the structure into a format suitable for rendering by the terminal, and outputs display information containing organized sections, lists, and emphasis markers.

### Step 15

The server records history information, including the input data, the prompt sentence, the selected past cases, and the structured response, in the information storage device.

The server takes, as input, identifiers for the current session, references to uploaded files, the constructed prompt sentence, the identifiers of selected past case records, and the structured representation of the response.

The server writes this information into one or more database tables, creates or updates records that represent new past cases or subcases as appropriate, stores associated semantic representation vectors, and outputs persistent history entries that can be reused as future past case information.

### Step 16

The server transmits the display information to the terminal for user presentation.

The server uses, as input, the formatted display information associated with the current session.

The server encapsulates the display information into a response message, sends the message over the communication network to the terminal, and outputs a network-level response that completes the server-side handling of the request.

### Step 17

The terminal receives the display information from the server and renders it on the display device.

The terminal uses, as input, the server's response message containing the structured and formatted display information.

The terminal parses the message, maps sections to visual components such as panels and lists, applies layout and styling rules, and outputs rendered content on the display device in a form where proposal information, explanatory information, and cautionary information are visually distinguishable.

### Step 18

The user reviews the displayed information and optionally provides additional instructions for refinement.

The user receives, as input, the displayed content on the terminal, including AI-generated strategies, explanations, and cautions.

The user evaluates the usefulness of the information, modifies presentation materials accordingly, and may output new control input on the terminal, such as a further natural-language request to “make the strategy more concise” or “add financial metrics,” which is then passed back into Step 1 as new input data for another processing cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented support systems for planning activities such as campaigns or projects typically either rely on manually crafted templates or on simple retrieval of past examples from a database. In these systems, a processor usually applies straightforward keyword matching or rule-based selection to retrieve prior records and then presents those records, or slightly edited versions thereof, to a user. Such architectures suffer from several technical limitations from the perspective of computer technology itself.

First, conventional systems fail to exploit the full structure of large-scale historical data because they do not automatically derive higher-level patterns that correlate descriptive features of past records with quantitative performance indicators. Databases and storage devices are treated as passive repositories from which records are fetched, rather than as sources for dynamically computed “success patterns” that can be represented as machine-readable structures. As a result, the processor does not maintain an internal representation that effectively encodes relationships between heterogeneous attributes (such as timing, medium, and target attributes) and performance metrics, and the computational pipeline is not optimized to guide subsequent automated generation processes.

Second, even when modern generative AI models are employed, existing systems tend to construct prompts in an ad hoc or static manner. A processor often embeds raw user text directly into a prompt and sends it to a generative AI model without systematically incorporating structured analysis of the user's input and past data. This leads to unstable quality of generated outputs, inefficient use of computational resources, and lack of reproducibility. The generative AI model is not explicitly conditioned on machine-derived success patterns, and the system does not exploit similarity measures between current materials and past records to control the generative process. Consequently, the overall pipeline from data acquisition to prompt construction remains loosely coupled, and the processor cannot reliably produce context-aware prompts that align with stored data distributions.

Third, conventional iterative refinement mechanisms are frequently implemented as superficial re-prompts that simply append user feedback to previous text. The processor fails to maintain an updated internal “context object” that unifies (i) extracted key point information from new materials, (ii) selected success patterns, and (iii) user feedback obtained after one or more generation cycles. Because this machine-internal context is not systematically structured and reused, each iteration repeats largely redundant computation, does not leverage previously derived feature vectors and similarity scores, and thus increases latency and resource consumption on the computing apparatus.

Therefore, there is a need for an improved computer-implemented system and method that (i) automatically extracts structured success patterns from past records using statistical analysis or machine learning, (ii) selects such patterns for a given set of information materials using similarity between feature vectors, and (iii) generates and regenerates prompt sentences for a generative AI model based on a formally maintained context structure. Such a system should improve how a processor coordinates database access, natural language processing, feature computation, and prompt construction, thereby enhancing the technical functioning of the information processing apparatus, improving consistency and relevance of generated outputs, and reducing redundant computation during iterative refinement.

The specific processing by the specific processing unit 290 of the data processing device 12 in Application Example 1 is realized by the following means.

The present invention provides a server comprising a processor and a memory storing instructions that, when executed by the processor, cause the server to perform operations including: receiving, via an input mechanism, information materials from a user; acquiring past case information from a stored collection of record information; extracting character-based information from the information materials and performing natural language processing including tokenization, normalization of word forms, and element extraction to identify key point information; performing statistical analysis or machine learning-based feature extraction on description information and result information included in the past case information to derive success patterns that are common to successful past cases; computing similarity between feature vectors corresponding to the key point information and feature vectors corresponding to the success patterns and selecting, based on the similarity, one or more success patterns related to the information materials; structuring context information including the key point information and the selected success patterns; generating, based on the context information, a prompt sentence that explicitly specifies selection results as generation conditions and instructs a generative AI model to generate proposal information; transmitting the prompt sentence to the generative AI model and obtaining, as a response, proposal information generated on the basis of the context information; formatting the proposal information into a predetermined display format and outputting the formatted proposal information to a display device for presentation to the user; and receiving additional instructions or correction instructions from the user, updating the context information to include the additional instructions or the correction instructions together with the proposal information, regenerating the prompt sentence based on the updated context information, and iteratively causing the generative AI model to regenerate proposal information. This enables the server to internally compute and maintain structured success patterns and context-dependent feature representations, to construct machine-controlled prompt sentences that condition the generative AI model on selected patterns derived from past records, and to perform efficient iterative refinement with reduced redundant computation, thereby improving the technical performance, consistency, and responsiveness of the underlying information processing apparatus.

The term “information processing apparatus” refers to an electronic computing system including at least one processor, a memory, and one or more interfaces, which executes computer-readable instructions to perform data processing operations such as receiving inputs, accessing storage, and controlling external devices.

The term “processor” refers to one or more hardware processing units, such as a central processing unit or a graphics processing unit, capable of executing machine instructions to perform arithmetic, logical, and control operations.

The term “memory” refers to one or more hardware storage components, such as volatile or nonvolatile storage devices, that store instructions and data for access by the processor.

The term “input mechanism” refers to a hardware and software combination, such as a user interface, communication interface, or input device, through which a user or another system can provide data or commands to the information processing apparatus.

The term “display device” refers to a hardware output component, such as a screen, monitor, or head-mounted display, that visually presents information to a user.

The term “user” refers to a human operator or an entity that interacts with the system by providing input data or consuming output information.

The term “information materials” refers to data objects containing descriptive content, such as text documents, slide files, or other machine-readable representations, that describe a subject for which proposal information is to be generated.

The term “past case information” refers to a collection of records representing prior instances of activities or events, each record including at least descriptive attributes and associated performance or result data.

The term “record information” refers to structured or semi-structured data entries stored in a storage apparatus, each entry representing one case, event, or instance with associated attributes and values.

The term “case record” refers to an individual entry within the past case information that includes multiple fields, such as action content, target attributes, implementation timing, used medium, and evaluation indices.

The term “action content” refers to descriptive data indicating what actions or operations were performed in a particular past case.

The term “target attributes” refers to one or more data fields that describe characteristics of the intended audience, objects, or entities associated with a past case.

The term “implementation timing” refers to temporal information, such as dates, periods, or seasons, indicating when a particular case was executed.

The term “used medium” refers to one or more channels or platforms, such as communication channels or distribution media, that were employed in a particular case.

The term “evaluation indices” refers to numerical or categorical metrics used to quantify the performance, effectiveness, or outcome of a past case.

The term “numerical information regarding the evaluation indices” refers to quantitative values, such as scores, rates, or counts, that are assigned to evaluation indices for each case record.

The term “character-based information” refers to text data composed of characters, symbols, or strings that can be processed by natural language processing techniques.

The term “natural language processing” refers to a set of computational techniques for analyzing and transforming human-readable text, including operations such as tokenization, word form normalization, and entity extraction.

The term “tokenization” refers to the process of segmenting character-based information into smaller units, such as words, subwords, or sentences, for further analysis.

The term “normalization of word forms” refers to processing steps, such as stemming or lemmatization, that convert different inflected or derived forms of a word into a common base representation.

The term “element extraction” refers to the identification and selection of relevant linguistic units, such as keywords, key phrases, or named entities, from character-based information.

The term “key point information” refers to a subset of elements derived from information materials that represents essential topics, constraints, or objectives pertinent to generation of proposal information.

The term “description information” refers to text or structured fields in past case information that describe the content, configuration, or conditions of each case.

The term “result information” refers to data elements in past case information that express the outcomes or performance of each case, including evaluation indices and related metrics.

The term “feature extraction” refers to computational operations that transform raw data, such as text or numeric attributes, into machine-interpretable numerical representations called feature vectors.

The term “feature vector” refers to an ordered set of numerical values that encodes attributes or characteristics of information materials or past case information for use in similarity calculations or machine learning.

The term “statistical analysis” refers to computational methods, such as correlation analysis or clustering, applied to data to identify relationships, distributions, or patterns.

The term “machine learning-based feature extraction” refers to the use of trained or trainable computational models to derive feature vectors or patterns from input data.

The term “success patterns” refers to structured representations of combinations of elements, derived from groups of past case records that satisfy predetermined evaluation conditions, and expressing configurations correlated with favorable outcomes.

The term “information set” refers to a collection of data elements, such as multiple case records, grouped and handled as a logical unit by the system.

The term “structured data” refers to data organized in a predefined format, such as tables, records, or key-value pairs, that can be systematically processed by the information processing apparatus.

The term “similarity” refers to a quantitative measure indicating the degree of closeness or correspondence between two feature vectors or sets of features.

The term “context information” refers to an internally maintained data structure that includes key point information, selected success patterns, and optionally user feedback or generated proposal information, and that is used as a basis for constructing instructions to a generative AI model.

The term “prompt sentence” refers to a machine-generated textual instruction or query that is provided as input to a generative AI model and that specifies conditions, constraints, or objectives for generating output information.

The term “generative AI model” refers to a computational model, such as a neural network-based text generation system, configured to generate new content, including text, in response to a prompt sentence.

The term “proposal information” refers to output content generated by the generative AI model, based on the prompt sentence and context information, which suggests plans, options, or ideas for activities corresponding to the information materials.

The term “generation conditions” refers to constraints, parameters, or selection results included in or implied by the prompt sentence that direct how the generative AI model produces proposal information.

The term “selection results” refers to information indicating which success patterns or case records have been chosen as relevant for a given set of information materials.

The term “predetermined display format” refers to a structured layout or arrangement, such as sections or lists, in which proposal information is organized for display to a user.

The term “additional instructions” refers to user-provided input that supplements the current context information, such as requests for emphasis, scope changes, or new conditions.

The term “correction instructions” refers to user-provided input indicating modifications, rejections, or corrections to parts of the existing proposal information or context information.

The term “updated context information” refers to context information that has been modified to include additional instructions, correction instructions, or previously generated proposal information, and that is used to regenerate a prompt sentence.

The term “iteratively cause the generative AI model to regenerate” refers to repeatedly sending modified prompt sentences, based on updated context information, to the generative AI model to obtain revised proposal information in multiple cycles.

The server, the terminal, and the user each participate in implementing embodiments of the present invention. In the following description, the term “server” denotes an information processing apparatus including at least one processor, a memory, a storage device, and one or more communication interfaces; the term “terminal” denotes a user-operated device including a display device and input mechanism; and the term “user” denotes a human operator who interacts with the system.

The server includes, as hardware components, one or more central processing units, optionally one or more graphics processing units, a main memory implemented as semiconductor memory, a nonvolatile storage device such as a solid-state drive or hard disk drive, and a network interface controller connected to a communication network. The server executes an operating system and middleware including a web server framework, a database management system, and a runtime environment capable of executing programs written in a high-level language. The server further executes software modules implementing natural language processing, statistical analysis, machine learning, and communication with a remote generative AI model.

The terminal includes a processor, a memory, a display device such as a liquid crystal display or organic light-emitting diode display, and an input mechanism such as a touchscreen, keyboard, pointing device, microphone, or camera. The terminal executes a web browser or a native application that provides a graphical user interface. The terminal is configured to transmit user input and receive server output through a communication network using a communication protocol.

The user operates the terminal to provide information materials and to review proposal information generated by the system. The user utilizes user interface controls on the terminal to select files, enter text, and issue additional instructions or correction instructions. The user visually observes proposal information presented on the display device of the terminal and optionally modifies or approves the proposal information.

The server stores and executes a program that implements the claimed functions. The program is stored in the memory or storage device as machine-readable instructions. The program is organized into software modules including an input management module, a text extraction module, a natural language processing module, a feature computation module, a pattern derivation module, a similarity computation module, a context management module, a prompt generation module, a generative-model interface module, a post-processing module, and a presentation module.

The server uses a database management system to store past case information and derived success patterns. The database includes tables representing case records, each case record having fields for action content, target attributes, implementation timing, used medium, evaluation indices, and numerical information regarding the evaluation indices. The server also stores, in tables or key-value structures, feature vectors for information materials and past cases, and structured success patterns derived from groups of case records.

The server uses a natural language processing library to perform tokenization, normalization of word forms, and element extraction. The server loads model parameters for part-of-speech tagging, named entity recognition, and morphological analysis into memory and applies these models to character-based information extracted from information materials and past case descriptions. The server thereby produces sequences of tokens, normalized word forms, and extracted elements such as key phrases and named entities.

The server uses a feature computation module to convert textual and structured attributes into numerical feature vectors. The server represents text segments using word embeddings, sentence embeddings, or document embeddings. For example, the server may assign each token a dense real-valued vector learned by a neural network and compute weighted combinations of these vectors to form a document-level feature vector. The server also encodes categorical attributes such as target attributes and used medium using one-hot or multi-hot vectors and combines them with numeric evaluation indices to form extended feature vectors. These extended feature vectors are stored in the memory and in the database for later similarity computations.

The server uses a pattern derivation module to derive success patterns from the past case information. The server aggregates case records whose evaluation indices satisfy predetermined conditions, such as exceeding a threshold value or belonging to a top quantile. The server applies statistical analysis to these aggregated records, including correlation analysis between attributes and evaluation indices, and clustering based on feature vectors. In one embodiment, the server performs k-means clustering on the feature vectors of successful case records to identify clusters representing different types of success patterns. The server stores, for each cluster, representative attribute values, central feature vectors, and distribution statistics as structured data. These stored structures constitute success patterns that can be reused for new information materials.

The server uses a similarity computation module to compare feature vectors of current information materials with feature vectors of success patterns. The server computes similarity measures such as cosine similarity or Euclidean distance between a feature vector representing the key point information of the information materials and a feature vector representing each success pattern. The server evaluates similarity scores and selects one or more success patterns whose similarity exceeds a threshold or belongs to a top-ranked set. By performing this computation on precomputed feature vectors, the server reduces the number of database accesses and avoids repeated reprocessing of raw text, thereby improving processing efficiency and latency.

The server uses a context management module to construct and maintain context information. The context information is represented as a data structure such as a hierarchical key-value tree or a nested object, including fields for key point information, selected success patterns, feature vectors, user identifiers, timestamps, and user feedback. When the user provides additional instructions or correction instructions, the server updates the context structure by appending or modifying nodes representing these instructions and associating them with previously generated proposal information. This persistent internal context enables the server to reuse computations and to provide the generative AI model with a consistent and rich representation of the current state.

The server uses a prompt generation module to create a prompt sentence that instructs the generative AI model to generate proposal information. The server assembles segments of natural language text using templates and conditionally inserts key point information, selected success patterns, and any constraints or preferences indicated by the user. The server explicitly includes selection results of success patterns as generation conditions in the prompt sentence. For example, the server may generate a prompt sentence such as: “Based on the following new information materials and the following derived success patterns from past successful cases, generate several detailed campaign proposals.

New information materials:
A new wearable device for users in their 20 s and 30 s, to be promoted in the summer season.

Derived success patterns:
Summer season combined with limited-time discount and social media advertising tends to achieve high engagement.
Visual storytelling with short video content is effective for young adults.

Please output multiple proposal ideas, each including: campaign concept, key messages, recommended channels, and suggested promotional offers.”

The server may also generate a refinement prompt sentence such as:

“Based on the previous proposal and the user's feedback to focus more on social media and reduce the budget, refine the campaign plan to emphasize cost-efficient social platforms and shorter campaign duration, while preserving the core concept.”

The server communicates with a generative AI model running on a remote computation platform or on a local device. The generative AI model is implemented as a neural network having a transformer-based architecture with multiple layers of self-attention and feed-forward sublayers. The model maintains learned parameters including weight matrices and bias vectors. The model has been trained on a large corpus of text data using a training procedure that minimizes a loss function, such as cross-entropy between predicted tokens and actual tokens, and that updates weights using a gradient-based optimization algorithm. During inference, the generative AI model receives the prompt sentence as a sequence of tokens, processes the tokens through its layers, and outputs probability distributions over possible next tokens. The model generates proposal information by selecting tokens according to these distributions under predetermined decoding strategies.

The server uses a generative-model interface module to convert the prompt sentence into a format compatible with the generative AI model, transmit the prompt sentence over the network, and receive generated text as a response. The server specifies parameters such as maximum output length, temperature, and top-k or top-p sampling parameters to control diversity and coherence of the generated proposal information. Because the prompt sentence explicitly encodes selected success patterns and key point information in a structured and machine-determined way, the generative AI model is constrained to produce outputs that are more aligned with historically successful configurations, thereby improving the relevance and consistency of generated text.

The server uses a post-processing module to format the generated proposal information. The server analyzes the generated text to segment it into proposal units, identifies headings and bullet-like structures using pattern matching and linguistic markers, and organizes the text into sections such as “Campaign Overview,” “Key Messages,” “Channels,” and “Offers.” The server may also perform a validation check against constraints, such as required length or prohibited expressions, and may re-run generation with updated parameters if necessary. By implementing this structured post-processing, the server reduces the cognitive load on the user, ensures that output fits into predefined display formats on the terminal, and facilitates machine-readable storage for subsequent retrieval or analytics.

The server uses a presentation module to transmit formatted proposal information to the terminal and to output it to the display device. The server generates a structured response containing the proposal information and associated metadata, and sends it to the terminal over the network. The terminal receives the response, parses the structured data, and renders the content using a layout optimized for the display device. The terminal may present multiple proposals in a list, each of which the user can expand to view details. The user can select, annotate, or compare proposals. The server thereby controls data flow and content organization such that the terminal can display information without performing heavy computation.

The user interacts with the system by evaluating the displayed proposal information on the terminal. The user may provide additional instructions, such as “increase emphasis on online video,” “avoid discount-based messaging,” or “adapt for a different target age group.” The user may enter such instructions through a text input field or select predefined options. The terminal transmits these inputs to the server. The server updates the context information to incorporate the new instructions and the associated proposal information, and then regenerates a refined prompt sentence that explicitly incorporates these updated conditions. The server thereby implements an iterative refinement loop in which internal feature representations, selected success patterns, and user feedback are all used as inputs to prompt construction.

In one embodiment, the server improves processing speed and reduces communication load by caching feature vectors and success patterns. The server stores feature vectors for frequently used information materials and success patterns in fast-access memory. When similar materials are processed, the server retrieves precomputed vectors instead of recomputing them from raw text. The server also stores selection results for groups of materials and patterns, so that similarity computations can be partially reused. By minimizing repeated computations and redundant data transfers, the server reduces overall latency and improves responsiveness.

In another embodiment, the server employs alternative algorithms for feature extraction and pattern derivation. The server may use a convolutional neural network or a recurrent neural network to derive sentence-level representations, or may employ dimensionality reduction techniques such as principal component analysis to compress feature vectors. The server may also vary clustering methods for deriving success patterns, such as density-based clustering or mixture models, depending on the distribution of evaluation indices and attributes. These variations share the common characteristic that the server internally computes, stores, and reuses structured patterns that link descriptive features to performance measures.

In another embodiment, the server controls additional devices or software systems based on the generated proposal information. For example, the server may generate configuration files or scheduling instructions for external campaign management systems, and may automatically populate parameter fields based on proposed channels and timing. By generating machine-readable configuration data that directly controls external systems, the server further demonstrates that the invention leads to concrete control of technical equipment rather than remaining at the level of abstract ideas.

The server achieves technical improvements over conventional systems because the server does not merely automate human planning steps; instead, the server reorganizes internal computer operations in a particular way. Specifically, the server (i) transforms raw text and structured records into high-dimensional feature vectors optimized for similarity computations, (ii) derives and persists success patterns that compress high-volume historical data into compact, reusable structures, (iii) uses these structures to systematically constrain prompt generation for a generative AI model, and (iv) maintains a machine-internal context object that is updated and reused across iterations. This pipeline reduces the number of times raw data must be re-parsed, improves cache utilization, and decreases the volume of data transmitted to the generative AI model, thereby improving computational efficiency, memory usage, and network bandwidth consumption.

The causal relationship between these operations and technical effects can be described as follows. By using feature vectors and similarity computations, the server can quickly identify relevant subsets of past case information without scanning entire databases linearly, thereby reducing search time. By deriving success patterns and storing them as structured data, the server converts large, redundant record sets into compressed representations that can be accessed and transmitted in fewer operations, improving throughput. By embedding these success patterns and selection results directly into prompt sentences as explicit generation conditions, the server guides the generative AI model toward a narrower, more relevant output space, which reduces the expected length and variability of model outputs and facilitates faster post-processing. By maintaining an updated context information structure, the server avoids recomputing intermediate features and repeatedly re-deriving patterns for each iteration, which reduces redundant computation and improves latency. These changes in data structures and control flow therefore improve the technical performance of the overall system.

The AI processing in the present invention differs from conventional human decision-making in several ways. The server applies similarity metrics on high-dimensional feature vectors that humans cannot directly interpret or compute without specialized tools. The server derives success patterns based on clustering and statistical correlation at a scale that exceeds human capacity. The server constructs prompt sentences based on machine-computed selection results and structured context information, following deterministic rules that ensure reproducibility and traceability. The generative AI model itself operates based on a transformer architecture with learned attention weights and non-linear transformations that do not correspond to simple human rules. As a result, the system yields computational behaviors and technical properties that are not achievable by direct human reasoning or by naïve automation of manual tasks.

In further alternative embodiments, the server may employ different types of generative AI models, such as encoder-decoder architectures or models specialized for particular domains. The server may adjust internal parameters of these models, such as learning rates during fine-tuning, batch sizes, and regularization coefficients, to optimize performance for specific datasets. The server may also perform domain-specific pretraining or adaptation of the models using additional corpora, employing loss functions that balance generic language modeling objectives with domain-specific objectives, such as matching historical success distributions. These variations maintain the core concept that the server uses machine-learned models in combination with derived success patterns and structured prompts to control generation in a technically advantageous manner.

Accordingly, the server, the terminal, and the user cooperate to implement the claimed system. The server performs specialized data transformations, pattern derivations, similarity computations, prompt generation, and generative-model interfacing that collectively improve the internal functioning of the computing environment and produce physically instantiated changes in memory, storage, and communication states. The terminal presents these results in a user-accessible form and allows the user to influence subsequent iterations. Through these mechanisms, embodiments of the present invention provide a concrete technical implementation that improves computer technology itself, rather than merely automating an existing human process.

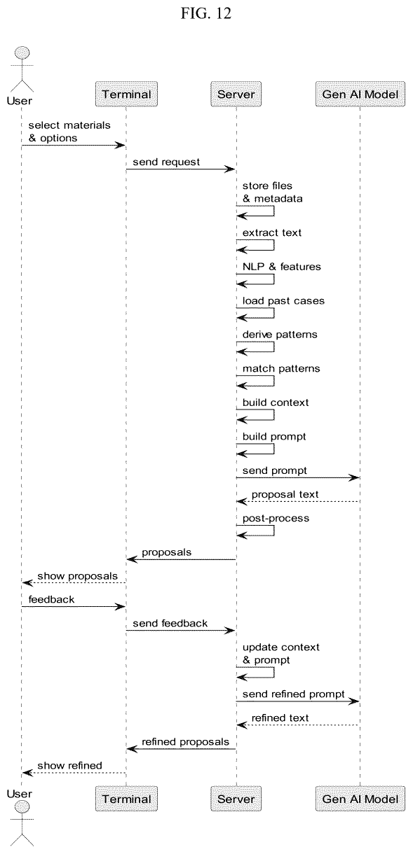

The following describes the processing flow using FIG. 12.

### Step 1

The user prepares information materials and past case data on the terminal. The user selects one or more files (such as slide files, document files, or text files) and, if needed, selects identifiers of past cases stored remotely. The terminal receives these selections as input and displays a user interface for confirmation. The terminal converts the selected materials and metadata (for example, campaign type, target audience, and time period) into a request payload. The terminal sends this payload as an HTTP or HTTPS request to the server. The output of this step is a structured request containing information materials and associated metadata transmitted from the terminal to the server.

### Step 2

The server receives the HTTP or HTTPS request from the terminal via a communication interface. The server parses the request headers and body to extract uploaded files, case identifiers, and user-specified parameters. As input, the server uses the raw binary files and structured metadata from the terminal. The server validates file types and sizes by comparing MIME types and file extensions against an allowed list and checking file size limits. The server then stores the raw files in a storage device and registers metadata records in a database, assigning internal IDs to each information material and user session. The output of this step is a set of stored files and database records that reference the received information materials and configuration parameters.

### Step 3

The server loads the stored information material files from the storage device using the assigned internal IDs. The server treats each file as input and determines its format (for example, slide format, PDF format, or plain text format) based on file headers or extensions. The server applies format-specific text extraction procedures: for slide files, the server reads slide titles, body text, and notes; for PDF files, the server extracts text from each page; for text files, the server reads the entire content directly. The server concatenates the extracted text segments into a single character-based string per material and removes non-textual elements such as control characters. The output of this step is cleaned character-based information representing each information material.

### Step 4

The server applies natural language processing to the character-based information. As input, the server uses the cleaned text for each information material. The server tokenizes the text into sentences and tokens, normalizes word forms through stemming or lemmatization, and removes stop words. The server further performs part-of-speech tagging and named entity recognition to identify nouns, verbs, product names, organization names, time expressions, and other entities. Using these processed tokens and entities, the server calculates term frequencies and identifies key phrases using statistical measures such as TF-IDF or rule-based phrase extraction. The server designates these key phrases and entities as key point information. The output of this step is a structured representation for each information material, including token lists, normalized forms, and key point information.

### Step 5

The server computes feature vectors for the information materials. As input, the server uses key point information, token sequences, and any structured attributes provided by the user (such as target age range or region). The server maps tokens to embedding vectors and aggregates them using functions such as averaging or attention-based weighting to obtain document-level embeddings. The server encodes categorical attributes (for example, media type or season) into numerical vectors and concatenates them with the document embeddings. The server normalizes these feature vectors, for example by scaling to unit length, and stores them in memory and in the database with references to the corresponding information materials. The output of this step is a set of numerical feature vectors that represent the semantic and attribute content of each information material.

### Step 6

The server retrieves past case information from the database. As input, the server uses case identifiers specified by the user or default selection criteria (such as all cases within a particular domain or time window). The server executes database queries to fetch action content, target attributes, implementation timing, used medium, evaluation indices, and numerical values for each selected case record. The server also retrieves any previously computed text features or embeddings for these cases if they exist. The server aggregates this data for subsequent analysis. The output of this step is a collection of structured case records and associated feature representations.

### Step 7

The server performs feature extraction and pattern derivation on the past case information. As input, the server uses the descriptive text of each case, structured attributes, and evaluation indices. If text features are not yet available, the server processes the case descriptions through the same natural language pipeline and embedding mechanism used for the information materials. The server then combines text embeddings with encoded attributes and evaluation indices to form case feature vectors. The server identifies successful cases by applying conditions to the evaluation indices, such as selecting cases whose performance metrics exceed a predefined threshold. The server executes clustering algorithms or correlation analyses on the successful case feature vectors to find groups of similar successful cases. For each group, the server computes representative attribute values and central feature vectors, and stores them as success patterns. The output of this step is a structured set of success patterns, each linked to statistical information and representative case features.

### Step 8

The server computes similarity between the information material feature vectors and the success pattern feature vectors. As input, the server uses the feature vector of each information material and the feature vectors representing each success pattern. The server calculates similarity scores, for example using cosine similarity, between each material vector and each pattern vector. The server ranks the patterns for each material according to the similarity scores and selects one or more top-ranked patterns that satisfy a ranking threshold or a similarity threshold. The server then creates a mapping between the current information materials and their selected success patterns. The output of this step is a list of selected success patterns for each information material, with associated similarity scores.

### Step 9

The server assembles context information for prompt generation. As input, the server uses the key point information for each information material, the selected success patterns, the similarity scores, and any additional constraints or preferences provided by the user. The server creates a structured context object that includes sections for “New Information Materials,” “Derived Success Patterns,” and “User Constraints.” The server populates these sections with concise summaries and numerical indicators, such as which pattern cluster was selected and with what similarity. The server stores this context object in memory linked to the current session and user. The output of this step is a fully constructed context information structure that is ready to be translated into a prompt sentence.

### Step 10

The server generates a prompt sentence for a generative AI model. As input, the server uses the context information structure from Step 9. The server applies template-based text generation rules that specify the order and phrasings of sections in the prompt. The server inserts summarized information materials, explicitly enumerated success patterns, and generation conditions such as requested number of proposals or required sections in the output. The server ensures that selection results, including references to high-performing combinations of attributes, are clearly expressed. For example, the server may generate a prompt sentence including phrases such as “Based on the following derived success patterns from past successful cases, generate several detailed campaign proposals.” The output of this step is a complete prompt sentence (or prompt text) in natural language that can be sent to the generative AI model.

### Step 11

The server communicates with the generative AI model using the generated prompt sentence. As input, the server uses the prompt sentence and model control parameters such as maximum token count, sampling temperature, and diversity constraints. The server packages the prompt sentence into a request format acceptable to the generative AI model's interface and transmits the request via a network connection. The generative AI model processes the prompt and returns generated text as a response. The server receives this response, decodes the returned content, and extracts the generated proposal information as a sequence of tokens or strings. The output of this step is raw generated proposal information associated with the original prompt and context.

### Step 12

The server post-processes the generated proposal information. As input, the server uses the raw generated text produced by the generative AI model. The server parses the text to identify proposal boundaries, headings, and bullet-like items using pattern recognition and language rules. The server divides the text into structured components such as campaign title, overview, key messages, recommended channels, and suggested offers. The server may correct minor formatting issues, remove duplicate segments, and validate that the output respects predefined constraints or policies. The server constructs a structured internal representation and then converts it to a format suitable for the terminal, such as a hierarchical object or markup-based structure. The output of this step is structured, cleaned proposal information ready for display.

### Step 13

The server prepares a response message and sends the proposal information to the terminal. As input, the server uses the structured proposal information and context identifiers linked to the user session. The server formats the data into a response payload and associates metadata such as proposal IDs and timestamps. The server transmits this payload to the terminal over the communication network. The terminal receives the response and parses it. The terminal then renders the proposal information on the display device, organizing it into visual elements such as cards, lists, or detailed views. The output of this step is a visual presentation of the proposal information on the terminal's display device, accessible to the user.

### Step 14

The user reviews the displayed proposal information on the terminal. The user reads the campaign concepts, key messages, and recommended channels. Based on this input, the user decides whether adjustments are needed. The user may type additional instructions, select options, or mark specific elements for correction. The terminal collects these user actions as input data and packages them into an update request. The terminal sends this update request, including the user's additional instructions or correction instructions and references to the affected proposal information, to the server. The output of this step is an instruction payload expressing user feedback transmitted from the terminal to the server.

### Step 15

The server updates the context information and regenerates refined prompt sentences based on user feedback. As input, the server uses the user's additional instructions or correction instructions, the existing context information, and the previously generated proposal information. The server integrates the new instructions into the context object by adding or updating fields that reflect changes in desired emphasis, constraints, or exclusions. The server then repeats the prompt generation process using the updated context: the server constructs a new prompt sentence that explicitly references both the previous proposal and the user's feedback, and that directs the generative AI model to revise the proposal accordingly. The server sends this refined prompt sentence to the generative AI model, receives revised proposal information, post-processes it, and transmits it back to the terminal for display. The output of this step is updated proposal information and an updated context, enabling iterative refinement until the user is satisfied.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented support systems for preparing presentations typically provide only static templates, generic checklists, or manually curated examples of questions and answers. Such systems do not automatically analyze the actual content of a presentation file, do not leverage accumulated past interaction data in a structured and dynamic manner, and do not generate context-specific question-and-answer pairs tailored to the particular presentation and user context. As a result, the computational resources of the system are underutilized, and the user must perform substantial manual work to anticipate questions and prepare answers, which leads to inefficiencies in information processing and degraded usability.

Further, existing data processing techniques that use machine learning or generative models often accept only a simple textual prompt manually prepared by the user, without automated extraction of features from presentation materials and without systematic use of a curated dataset of past cases. Consequently, the quality and relevance of generated content depend heavily on the user's ability to craft an appropriate prompt, and the computing system fails to consistently generate high-quality responses across different users and presentation topics. This results in an unstable and non-repeatable behavior of the generative model, and the information processing pipeline is not optimized for structured retrieval and transformation of domain-specific knowledge.

Moreover, typical database-backed systems simply retrieve past records matching a keyword and present them as-is, without integrating them into a machine-generated prompt sentence and without performing iterative filtering or structuring of generated outputs. Such architectures lack an integrated mechanism to: (i) extract feature information from complex document formats, (ii) search and rank a group of past cases based on similarity to the extracted features, (iii) construct a machine-oriented prompt sentence that encapsulates both the feature information and the past case information, and (iv) post-process generative outputs into structured, high-utility result information. This leads to suboptimal use of storage and processing resources, and prevents the system from achieving a consistent, high level of performance in generating question-and-answer candidates.

Therefore, there is a need for an improved computer-implemented technique that configures a processor to execute a specific sequence of operations: extracting feature information from presentation material files, automatically retrieving and structuring relevant past case information from a storage unit, constructing and transmitting an optimized prompt sentence to a generative AI model, and selecting and formatting high-quality question-and-answer candidates as result information. By improving the internal data processing pipeline and the interaction between the processor, the storage system, and the generative AI model, such a system can enhance the technical performance, stability, and usefulness of computer-based support for presentation preparation, thereby improving the functioning of the computer system itself.

The specific processing by the specific processing unit 290 of the data processing device 12 in Example 2 is realized by the following means.

The present invention provides a server comprising a processor configured to receive, from a user via an information processing apparatus, a presentation material file and accept the presentation material file as input data; to extract character information from the presentation material file and generate feature information by performing natural language processing on the extracted character information, including dividing the character information into word sequences and phrase sequences and assigning part-of-speech information and importance information; to search, based on the feature information, a stored group of past cases in an association information storage unit and extract past case information having high relevance according to a similarity between the feature information and each past case; to integrate the feature information and the past case information as context information in accordance with a predetermined format and generate a prompt sentence that instructs a generative AI model to generate anticipated questions and answer examples; to transmit the prompt sentence to the generative AI model and acquire, from the generative AI model, a plurality of question-and-answer candidates generated by inference processing of the generative AI model; to select, from the plurality of question-and-answer candidates, question-and-answer candidates that satisfy a predetermined criterion based on at least one of a degree of duplication, a length, and a keyword inclusion status, and to format the selected question-and-answer candidates as result information in a form of structured data or a document file; and to transmit the result information to the information processing apparatus and present the result information to the user in a displayable or downloadable format. This enables an improved computer-implemented processing pipeline in which document analysis, feature extraction, case-based retrieval, prompt sentence construction, generative inference, and structured post-processing are integrated to more efficiently utilize computational and storage resources, to stabilize and enhance the relevance and consistency of outputs from the generative AI model, and to provide the user with context-appropriate question-and-answer candidates that improve the overall functioning and technical performance of the presentation support system.

The term “information processing apparatus” refers to an electronic device including at least a processor, a memory, and an input/output interface, such as a general-purpose computer, a portable terminal, or a display device, which is configured to send data to and receive data from a server and to present information to a user.

The term “presentation material file” refers to a data file that contains content for a presentation, including at least character information and optionally image information or layout information, such as a slide file, a document file, or an electronic page file.

The term “character information” refers to textual content extracted from a presentation material file, including letters, numbers, symbols, and punctuation marks represented in a machine-readable form.

The term “feature information” refers to information representing salient characteristics of character information, including at least word sequences, phrase sequences, part-of-speech information, and importance information, used to characterize a topic or context of the presentation material file.

The term “natural language processing” refers to a computational technique executed by a processor to analyze and process character information written in a human language, including at least tokenization, part-of-speech tagging, phrase extraction, and importance estimation.

The term “word sequence” refers to an ordered set of one or more tokens representing words obtained by processing character information.

The term “phrase sequence” refers to an ordered set of tokens representing a phrase or multi-word expression derived from character information through natural language processing.

The term “part-of-speech information” refers to grammatical category information associated with each token or phrase, such as noun, verb, adjective, or other syntactic roles, obtained by natural language processing.

The term “importance information” refers to a value or attribute indicating a relative significance of a word, phrase, or feature with respect to a document or set of documents, determined by statistical analysis, rule-based processing, or machine learning.

The term “association information storage unit” refers to a storage subsystem, including at least a memory device and a control mechanism, that stores a group of past cases and allows reading and writing of data by a processor using an access protocol or query language.

The term “group of past cases” refers to a set of stored records, each record including information relating to at least presentation content information, related keyword information, question-and-answer content information, and reaction information to the question-and-answer content information.

The term “past case information” refers to information included in one or more records of the group of past cases, selected based on similarity to feature information, and used as contextual data for generating question-and-answer candidates.

The term “similarity” refers to a quantitative or qualitative measure of correspondence between feature information and past case information, determined based on at least one of keyword overlap, semantic proximity, or statistical correlation.

The term “context information” refers to combined information that includes at least feature information derived from the presentation material file and past case information retrieved from the association information storage unit, arranged in a form suitable for input to a generative AI model.

The term “prompt sentence” refers to a machine-readable textual instruction generated by a processor that includes context information and directives to a generative AI model, and that is configured to cause the generative AI model to output anticipated questions and corresponding answer examples.

The term “generative AI model” refers to a computational model implementing a machine learning architecture, such as a neural network-based language model, that is configured to generate new natural language text based on an input prompt sentence through inference processing.

The term “inference processing” refers to a computational operation performed by a generative AI model in which the model receives an input prompt sentence and calculates, using stored parameters, a sequence of output tokens forming generated text.

The term “question-and-answer candidate” refers to a pair of generated text segments, including a question portion and an answer portion, produced by a generative AI model in response to a prompt sentence.

The term “result information” refers to processed output data that includes at least selected question-and-answer candidates formatted by a processor into a structure suitable for presentation to a user, such as structured data or a document file.

The term “structured data” refers to data that is organized according to a predefined schema, such as a record, table, or hierarchical structure, enabling programmatic access and manipulation of individual elements including questions and answers.

The term “document file” refers to an electronic file that contains text and optionally layout, formatting, or graphic elements, such as a formatted page file that can be displayed, printed, or downloaded by an information processing apparatus.

The term “displayable format” refers to a data format that can be directly rendered by an information processing apparatus on a visual interface, such as a markup format, a text format, or a graphical layout format.

The term “downloadable format” refers to a data format that can be transferred from a server to an information processing apparatus and stored in a storage device for later access, including but not limited to document files, structured data files, or archive files.

The term “degree of duplication” refers to a measure of similarity or redundancy among multiple question-and-answer candidates, used by a processor to identify and reduce repetitive or overlapping content.

The term “length” refers to a quantitative measure of the size of a question-and-answer candidate, such as a number of characters, tokens, or sentences, used by a processor as part of a selection criterion.

The term “keyword inclusion status” refers to information indicating whether and to what extent a question-and-answer candidate includes one or more keywords or feature elements related to the presentation material file.

In one embodiment, the server is implemented as a physical computing machine including at least one central processing unit (CPU), a main memory, a non-volatile storage device, a network interface, and a graphics adapter. The server executes a server-side program on an operating system such as a general-purpose server operating system. The server-side program is implemented, for example, using an application framework and a scripting language, and the server exposes a network-based interface (for example, a REST-type interface) to communicate with the terminal.

The terminal is implemented as a computing device such as a notebook computer, a tablet device, or a smartphone including at least one CPU, a memory, a storage device, a display, and an input device. The terminal executes a web browser or a dedicated client application. The terminal enables the user to select a presentation material file stored in a local storage unit and to transmit the selected file to the server through a communication network.

The user operates the terminal to open a user interface that displays a file selection component and a transmission component. The user selects a presentation material file, such as a slide file or a document file, that contains content for an upcoming presentation. The user confirms an operation to send the selected file to the server. The terminal reads the selected presentation material file from the local storage device and transmits the file to the server via the network interface using a network protocol. The transmission may include metadata such as file type, file size, and user identification information.

The server receives the presentation material file from the terminal and stores the file in a storage region of the non-volatile storage device. The server determines a file format of the received file based on at least a file extension and a header of the file. When the file is a slide file or a document file, the server invokes a document analysis module implemented as a library program. The server loads the file into memory and parses internal structures, such as page objects, slide objects, text containers, and layout information, to extract character information from visible text regions. The server normalizes the extracted character information by removing control codes, merging fragmented text segments, and unifying character encodings into a common encoding.

The server executes a natural language processing module implemented, for example, using a library for language processing. The server loads a language model including parameters for tokenization, part-of-speech tagging, and phrase recognition. The server applies the language model to the normalized character information to generate a sequence of tokens. Each token is associated with part-of-speech information and may be associated with syntactic dependency information. The server further identifies candidate phrases such as noun phrases, verb phrases, and domain-specific multi-word expressions based on syntactic patterns and statistical co-occurrence. The server computes importance information for each token and phrase using at least one algorithm such as term frequency-inverse document frequency, mutual information, or an attention-based scoring derived from a pre-trained embedding model. The server aggregates selected high-importance tokens and phrases as feature information representing a content profile of the presentation material file.

The server accesses an association information storage unit implemented as a relational database or a key-value store. The association information storage unit stores a group of past cases as structured records. Each record includes presentation content information, related keyword information, question-and-answer content information, and reaction information to the question-and-answer content information. The reaction information may include attributes such as frequency of use, user rating, or performance metrics, which are stored in dedicated fields. The server executes a similarity search algorithm that compares the feature information from the current presentation material file with records in the group of past cases. To perform this comparison, the server may transform the feature information and the stored keyword information into vector representations using an embedding model and then compute similarity scores using cosine similarity or other distance measures. Alternatively or additionally, the server may perform full-text search using inverted indexes and ranking functions.

The server selects a subset of the group of past cases whose similarity scores exceed a threshold or whose ranking positions fall within a top set. The server extracts from the selected past cases the presentation content information and exemplary question-and-answer content information. The server also accesses the reaction information to prioritize past question-and-answer pairs that historically yielded favorable outcomes, such as higher ratings or stronger effectiveness indicators. The server composes past case information as context information by combining the feature information and the selected past case records into a structured, but eventually textual, representation.

The server generates a prompt sentence configured to act as an instruction for a generative AI model. The server constructs the prompt sentence by embedding both the feature information and the past case information into a pre-defined template. The template may provide explicit instructions on output format, number of question-and-answer pairs, language, and style constraints. For example, the server may generate a prompt sentence such as: “Based on the following presentation keywords and past Q&A examples, generate 10 likely audience questions and clear, concise answers that a presenter can use during a business presentation.

Presentation keywords: market entry, strategy, pricing, competition.

Past Q&A:
Q1: How do you plan to differentiate your product in a saturated market?
A1: We will focus on a clearly defined target segment and a unique combination of features that competitors do not provide.
Q2: What is your pricing strategy, and how did you validate it?
A2: We conducted market research and price sensitivity analysis to determine tiers aligned with customer value.

Please output the results as numbered question-answer pairs.”

The generative AI model used by the server is implemented, in one embodiment, as a transformer-based neural network including an input embedding layer, a plurality of self-attention layers, and an output projection layer. The server stores parameters of the neural network, such as weight matrices and bias vectors, in a model storage unit. During a training phase (which may be performed offline), the server or another training device trains the generative AI model using a large corpus of question-and-answer texts and presentation-related documents. The training process includes splitting the corpus into training data and validation data, defining a loss function such as cross-entropy loss on predicted token distributions, and performing gradient-based optimization, for example using stochastic gradient descent or an adaptive optimizer. The server updates the weights of the model by backpropagation, computing gradients of the loss function with respect to each weight and adjusting the weights iteratively until the loss converges or a stopping condition is satisfied. The training may further include data augmentation techniques such as paraphrasing or random masking of tokens to improve robustness.

During operation, the server uses the generative AI model in an inference mode only. The server inputs the prompt sentence into the model by converting each token of the prompt sentence into an embedding vector. The server propagates the embeddings through the self-attention layers, each layer computing attention scores between tokens using learned query, key, and value matrices. The server forms contextualized representations for each token and then produces a probability distribution over the vocabulary for the next token at each step. The server generates tokens sequentially according to an inference strategy such as greedy decoding or beam search, subject to constraints specified in the prompt sentence. This internal processing is performed using numerical linear algebra operations on the CPU or on an accelerator such as a graphics processing unit; the operations include matrix-vector multiplications, activation function evaluations, and normalization steps.

The server receives from the generative AI model a generated text output that contains multiple question-and-answer candidates. The server parses the generated text into individual pairs by detecting separators such as numbering patterns, line breaks, or pre-defined delimiters. The server evaluates each question-and-answer candidate against at least three criteria: a degree of duplication with other candidates, a length criterion (such as minimum and maximum token counts), and a keyword inclusion status that indicates whether core feature information from the presentation material file appears in the candidate. To determine the degree of duplication, the server computes text similarity metrics between candidates, such as n-gram overlap or cosine similarity of embedding vectors, and discards candidates whose similarity exceeds a threshold. To evaluate keyword inclusion status, the server counts occurrences of key phrases from the feature information in each candidate and can assign a score based on coverage. The server then selects candidates that satisfy a predetermined rule set, such as maximizing average keyword coverage while minimizing mutual duplication.

The server formats the selected question-and-answer candidates as result information. The server may represent the result information as structured data with fields for question text, answer text, associated keywords, and source indicators. The server may further generate a document file, such as a formatted page file, using a document generation library. In this process, the server lays out the question-and-answer pairs into sections, applies consistent formatting, and embeds additional metadata such as timestamps or presentation identifiers. The server transmits the result information to the terminal using a communication protocol. When the result information is a document file, the server provides a uniform resource locator for downloading the file.

The terminal receives the result information from the server and renders it on the display. The terminal may present the question-and-answer pairs in a list view or table view, allowing the user to scroll, search, and filter the entries. The user can download the document file and store it locally, or print it for physical use during the presentation. By using the terminal in this manner, the user can rely on a set of automatically generated and technically processed question-and-answer candidates that are specifically adapted to the content of the user's presentation.

This configuration provides technical effects that go beyond a mere automation of human mental work. The server enforces a particular data structure for feature information, past case information, and result information, and executes a non-generic sequence of computational transformations including document parsing, feature extraction, vector-based similarity computation, structured prompt sentence construction, neural inference, and post-generation filtering based on quantitative metrics. As a result, the server improves computational efficiency by reducing the search space of possible questions and answers using feature-based similarity, which decreases processing time for generating relevant outputs. The server also improves accuracy and consistency of generative outputs by supplying the generative AI model with context information that is systematically curated from past cases, thereby reducing variance in model behavior compared to naive free-form prompting.

In addition, the server improves data management within the association information storage unit by structuring past cases with explicit fields for reaction information and by using this reaction information as a parameter in the selection and ranking algorithms. This structure enables the server to prioritize question-and-answer candidates that historically produced favorable performance, thereby reducing error rates and improving the relevance of suggested content. Because the server performs these operations using defined algorithms and thresholds, the system can maintain stable performance even as the volume of stored past cases and the diversity of presentations increase.

Furthermore, the described system uses the generative AI model in conjunction with non-standard, rule-based filtering and context formatting operations that are not typically performed by human users. For example, the server's selection of candidates based on degree of duplication and keyword coverage follows computational rules that are not easily executed manually at scale. This combination of neural generation and deterministic post-processing yields a hybrid pipeline that leverages the strengths of statistical modeling while controlling for redundancy and topic drift, which is a technical improvement in the internal functioning of the computer system.

Alternative embodiments are possible. In one alternative, the server stores the group of past cases in a non-relational database, and the similarity search is performed using approximate nearest neighbor indexing on vector embeddings. In another embodiment, the server employs a smaller generative AI model for real-time usage and a larger model for batch generation, switching between models based on available computational resources to optimize latency and throughput. In yet another embodiment, the server updates the reaction information in the association information storage unit by collecting user feedback from the terminal and adjusting record-level scores using an online learning algorithm. These variations all maintain the fundamental structure in which the server uses feature information, similarity-based retrieval, and prompt sentence generation to control and improve the behavior of the generative AI model, thereby enhancing the technical performance of the overall system.

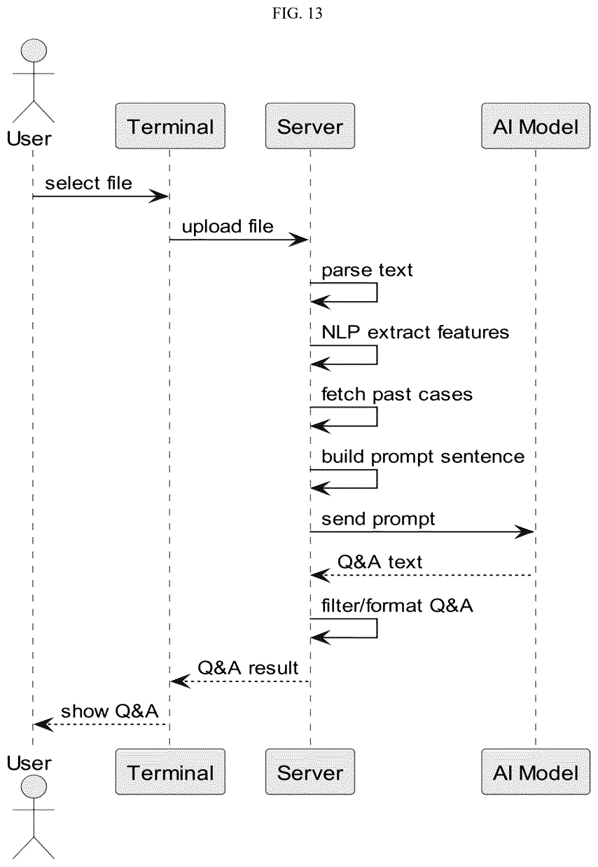

The following describes the processing flow using FIG. 13.

### Step 1

The user operates the terminal to select a presentation material file from a local storage unit and to initiate transmission of the file to the server.

The input of Step 1 is at least one presentation material file stored in the terminal and user operation information indicating a selection and a send command. The terminal reads the binary data of the selected file from a storage device, attaches file metadata such as file name, file type, and file size, and encapsulates the data into a network request. The terminal then performs a data transmission operation over a communication network to send the encapsulated request to the server. The output of Step 1 is a network message containing the presentation material file data and associated metadata delivered to the server.

### Step 2

The server receives the network message from the terminal and stores the presentation material file in a storage device for further processing.

The input of Step 2 is the network message including the binary file data and metadata. The server decodes the network protocol headers, verifies integrity and format of the received data, and writes the binary contents to a non-volatile storage region while generating an internal identifier for the stored file. The server also records an association between the internal identifier and the user session or user account. The output of Step 2 is a stored presentation material file referenced by an internal file identifier and a corresponding registration record in the server's storage.

### Step 3

The server determines a file format of the stored presentation material file and extracts character information from the file.

The input of Step 3 is the internal file identifier and the stored file data. The server inspects a file extension and a file header to classify the file as, for example, a slide file or a document file. Based on the classification, the server invokes a corresponding document parsing module that reads the file structure, iterates over pages or slides, and locates text containers. The server converts encoded text segments into a unified character encoding and concatenates them while removing control codes and non-displayable characters. The output of Step 3 is normalized character information representing textual content extracted from the presentation material file.

### Step 4

The server performs natural language processing on the character information to generate feature information.

The input of Step 4 is the normalized character information as a continuous text string. The server loads a language model and applies tokenization to split the text into tokens representing words or subwords. The server assigns part-of-speech information to each token using a tagging algorithm and detects phrase sequences such as noun phrases and verb phrases by analyzing syntactic patterns. The server computes importance information for each token and phrase using an algorithm such as term frequency-inverse document frequency or a scoring function based on vector embeddings. The server selects tokens and phrases that satisfy importance thresholds and aggregates them as feature information. The output of Step 4 is a set of feature information including word sequences, phrase sequences, part-of-speech labels, and importance scores.

### Step 5

The server searches an association information storage unit to retrieve past case information relevant to the feature information.

The input of Step 5 is the feature information generated in Step 4. The server converts selected keywords and phrases into a query representation, which may include both symbolic terms and numerical vectors. The server transmits a query to the association information storage unit, which stores a group of past cases. The server computes similarity scores between the feature information and stored keyword information, for example by calculating cosine similarity between vector embeddings or by applying a full-text search ranking function. The server then selects past case records whose similarity scores exceed a predetermined threshold or whose ranking positions fall within a specific range. The output of Step 5 is past case information consisting of one or more records that include presentation content information, related keyword information, question-and-answer content information, and reaction information.

### Step 6

The server generates context information by integrating the feature information and the retrieved past case information and then constructs a prompt sentence for a generative AI model.

The input of Step 6 is the feature information from Step 4 and the past case information from Step 5. The server formats the feature information as a list of presentation keywords and representative phrases and summarizes the past case information by selecting representative question-and-answer pairs and related context. The server arranges these components according to a predetermined template that includes explicit instructions for output length, structure, and style. The server concatenates the formatted feature information and past case summaries into a continuous text instruction. For example, the server may construct a prompt sentence such as: “Based on the following presentation keywords and past Q&A examples, generate 10 likely audience questions and clear, concise answers that a presenter can use during a business presentation.

Presentation keywords: market entry, strategy, pricing, competition.

### Past Q&A

Q1: How do you plan to differentiate your product in a saturated market?
A1: We will focus on a clearly defined target segment and a unique combination of features that competitors do not provide.
Q2: What is your pricing strategy, and how did you validate it?
A2: We conducted market research and price sensitivity analysis to determine tiers aligned with customer value.

Please output the results as numbered question-answer pairs.”

The output of Step 6 is context information represented as a structured instruction and a corresponding prompt sentence suitable for input to the generative AI model.

### Step 7

The server transmits the prompt sentence to the generative AI model and obtains a plurality of question-and-answer candidates generated through inference processing.

The input of Step 7 is the prompt sentence generated in Step 6. The server sends the prompt sentence to a generative AI model implemented on the same server or on a separate computing resource. The generative AI model processes the prompt sentence by converting tokens into vector embeddings, propagating them through multiple attention layers, and computing next-token probability distributions. The model generates a sequence of tokens that form natural language text containing multiple question-and-answer pairs. The server receives the generated text as a response. The output of Step 7 is generated text that includes a plurality of question-and-answer candidates associated with the presentation material file.

### Step 8

The server parses and evaluates the generated text to select question-and-answer candidates that satisfy predetermined criteria.

The input of Step 8 is the generated text received from the generative AI model. The server splits the text into individual question-and-answer candidates by detecting separators, numbering patterns, and line breaks. For each candidate, the server computes a degree of duplication with other candidates by measuring similarity of token sequences or embedding vectors. The server also measures the length of each candidate in terms of tokens or characters and determines a keyword inclusion status by checking whether feature information keywords appear in the question or answer. Based on these computed values, the server applies selection rules, such as discarding candidates with high duplication similarity or with insufficient keyword coverage, and retaining candidates whose length falls within a desired range. The output of Step 8 is a filtered set of question-and-answer candidates that satisfy the predetermined criteria.

### Step 9

The server formats the selected question-and-answer candidates as result information in a structured data format and, optionally, as a document file.

The input of Step 9 is the filtered set of question-and-answer candidates from Step 8. The server assigns identifiers to each candidate, associates metadata such as related keywords and similarity scores, and stores them as records in a structured data object. The server may further generate a document file by arranging the questions and answers into sections, applying layout rules, and embedding formatting elements such as headings and numbering. The data processing operations include mapping each pair to a predefined schema, ordering the pairs by relevance, and generating a serial representation suitable for storage or transmission. The output of Step 9 is result information comprising structured data and, in some embodiments, an accompanying document file containing the selected question-and-answer candidates.

### Step 10

The server transmits the result information to the terminal, and the terminal presents the result information to the user.

The input of Step 10 is the result information generated in Step 9. The server constructs a response message including the structured data and, if applicable, a link or binary stream for the document file. The server sends this response over the communication network to the terminal. The terminal receives the response, decodes the structured data, and renders the question-and-answer candidates on a display in a list or table format. If a document file is included, the terminal stores the file in local storage and may trigger a viewer application to open it. The output of Step 10 is a displayed or downloadable set of question-and-answer candidates that the user can inspect, edit, and utilize for preparation of the presentation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented question-and-answer support systems that use a generative AI model typically rely on static, manually crafted prompts and do not exploit rich contextual information or real-time user state. As a result, these systems suffer from several technical limitations.

First, the processor commonly generates a prompt sentence using only the immediate user input, without structured integration of past information such as historical question-and-answer records and reaction logs. This simplistic prompt construction underutilizes the capabilities of the generative AI model, leading to unstable output quality, low relevance of generated questions and answers, and increased variance in response style. Consequently, the system often requires repeated calls to the generative AI model or manual post-editing, which increases processing latency and computational load on the processor and the communication interface.

Second, conventional systems generally treat speech input and text input as separate, loosely coupled paths. Speech recognition results are not systematically fed back into the same keyword extraction and similar-case retrieval pipeline used for text. This fragmented processing architecture prevents efficient reuse of natural language processing components, leading to duplicated computation, increased memory usage, and inconsistent behavior between text-based and voice-based interactions, particularly in real-time dialog scenarios.

Third, typical systems do not incorporate emotion recognition into the prompt construction or response adjustment at the processor level. Emotion analysis, if present, is often handled as a superficial post-processing step that merely changes superficial wording. This architecture fails to use emotion state as a first-class parameter of the generative process, so the generative AI model cannot be guided to produce content that is computationally optimized for user condition, such as generating more structured, step-by-step answers when the user is anxious. As a result, the system cannot dynamically adapt its inference path or control parameters to stabilize output and reduce unnecessary repetitions, which degrades throughput and responsiveness.

Fourth, in real-time dialog environments, such as live presentations or in-person support scenarios, existing systems lack an integrated loop that combines speech recognition processing, natural language processing, prompt generation, generative AI inference, and emotion recognition in a coordinated and iterative manner. Without such an integrated loop, the processor cannot maintain a coherent session context that is continually updated by new user and environment signals. This results in fragmented state management, inefficient use of caches and session data, and increased end-to-end latency, which in turn make the system unsuitable for real-time overlays on terminal display devices such as wearable displays.

Accordingly, there is a need for a computer-implemented technique that improves the way a processor builds and updates prompt sentences and manages the interaction pipeline with a generative AI model. Such a technique should: structurally integrate past information and reaction data into the context; unify handling of speech-derived and text-derived inputs in a single processing flow; treat estimated emotional state as a computational parameter to adjust prompt and output content; and provide a real-time iterative loop that updates questions, answer examples, and feedback information with low latency. By addressing these technical issues, the processor, memory subsystem, and communication pathways of the system can be more efficiently utilized, resulting in improved stability, relevance, and responsiveness of generative AI-based support.

The specific processing by the specific processing unit 290 of the data processing device 12 in Application Example 2 is realized by the following means.

The present invention provides a server comprising a processor configured to receive information from a user as input, obtain past information from an information storage device, perform natural language processing on the received information and the obtained past information to extract important terms and generate context information including topic information and related information, search, based on the extracted important terms and the context information, an information set including past records of questions and answers to retrieve similar cases and obtain representative pairs of questions and answers, generate a prompt sentence that instructs a generative AI model to generate expected questions and answer examples based on the context information and the obtained pairs of questions and answers, transmit the generated prompt sentence to the generative AI model and obtain response information from the generative AI model, the response information including the expected questions and the answer examples, convert voice information transmitted from a terminal into character information by speech recognition processing and use the character information for the important-term extraction and the similar-case search, execute emotion recognition processing based on image information and voice information transmitted from the terminal to estimate an emotional state of a user and, according to the estimated emotional state, adjust at least one of content and expression format of the prompt sentence or the response information, present the obtained response information and feedback information corresponding to the emotional state to a display device of the terminal and, as needed, output print data to an output device, and, in a real-time dialog, repeatedly execute the speech recognition processing, the natural language processing, generation processing by the generative AI model, and the emotion recognition processing, and present successively updated questions, answer examples, and feedback information to the display device. This enables the processor to integrate heterogeneous inputs and past data into a unified context, construct and update prompt sentences in a computationally efficient and emotion-aware manner, stabilize and improve the relevance of generative AI outputs, and provide low-latency, real-time support on terminal display devices, thereby improving overall performance and usability of the computer-implemented question-and-answer support system.

The term “processor” refers to a hardware computing element, such as a central processing unit or an integrated processing circuit, that executes machine-readable instructions to perform the functions described in the system.

The term “user” refers to a person or an entity that operates a terminal or provides information to the system, and that receives questions, answer examples, and feedback information from the system.

The term “information” refers to data provided by the user, including but not limited to text data, documents, presentation materials, product descriptions, and topic selections, that are processed by the processor.

The term “past information” refers to data previously stored in an information storage device, including past questions, answers, information materials, reaction records, and evaluation information, that are used to support generation of new questions and answer examples.

The term “information storage device” refers to a computer-readable memory device, such as a database system, non-volatile memory, or storage medium, configured to store the past information and related data used by the processor.

The term “natural language processing” refers to a set of computational techniques for analyzing and processing human language text, including tokenization, part-of-speech tagging, keyword extraction, entity recognition, and context analysis.

The term “important terms” refers to words, phrases, or linguistic units extracted by natural language processing that are determined to be relevant to topics, questions, or answers in the received information and past information.

The term “context information” refers to structured data generated from the received information and the past information, including topic information, related information, summaries, and relationships among important terms.

The term “topic information” refers to data indicating main subjects, themes, or categories identified within the received information and the past information by the natural language processing.

The term “related information” refers to data that describes relationships among topics, important terms, and past records, and that provides additional detail or background for use in constructing prompt sentences and responses.

The term “information set” refers to a collection of data stored in the information storage device, including past records of questions, answers, information materials, reactions, and evaluations, that is searched by the processor.

The term “past records of questions and answers” refers to stored textual or structured records in the information set that describe previously asked questions and their corresponding answers.

The term “similar cases” refers to subsets of the information set, including past records of questions and answers and related context, that are determined by the processor to be similar to the current information based on important terms and context information.

The term “representative pairs of questions and answers” refers to selected pairs of past questions and corresponding answers, obtained from similar cases, that are used by the processor as examples for prompt construction and generation.

The term “prompt sentence” refers to a text instruction generated by the processor that is provided as input to a generative AI model to specify a generation task, including generation of expected questions, answer examples, and optionally feedback information.

The term “generative AI model” refers to a machine learning model configured to generate natural language text responses, such as questions and answer examples, based on an input prompt sentence and internal learned parameters.

The term “expected questions” refers to questions generated or obtained by the processor, via the generative AI model and similar-case search, that are predicted to be likely or relevant given the received information and context.

The term “answer examples” refers to natural language responses generated or obtained by the processor, via the generative AI model and similar-case search, that serve as model answers to the expected questions.

The term “response information” refers to data obtained from the generative AI model in response to the prompt sentence, including expected questions, answer examples, and optionally additional explanatory text.

The term “terminal” refers to an electronic device operated by the user, such as a computing device, portable device, or wearable device, that communicates with the server, transmits input information, and displays response information and feedback.

The term “voice information” refers to audio data captured by a microphone of the terminal that represents speech from the user or from another person in a dialog.

The term “speech recognition processing” refers to computational processing for converting voice information into character information, such as text, by analyzing and recognizing spoken language.

The term “character information” refers to textual data resulting from speech recognition processing of voice information, suitable for natural language processing and further analysis by the processor.

The term “image information” refers to visual data, such as still images or video frames, captured by an imaging component of the terminal and transmitted to the server for analysis.

The term “emotion recognition processing” refers to computational processing that analyzes input data, including image information, voice information, or text, to estimate an emotional state of the user or another person.

The term “emotional state” refers to a psychological condition of a user, such as anxiety, confidence, or neutrality, estimated by emotion recognition processing on image information and voice information.

The term “content of the prompt sentence or the response information” refers to textual substance, such as wording, structure, level of detail, and topics, contained in the prompt sentence or the response information.

The term “expression format” refers to formal characteristics of generated or adjusted text, including style, tone, level of politeness, length, and structural organization.

The term “feedback information” refers to additional information generated or selected by the processor on the basis of the estimated emotional state, including advice, guidance, and psychological support messages presented to the user.

The term “display device of the terminal” refers to a visual output unit associated with the terminal, such as a screen, monitor, or wearable display, that presents response information and feedback information to the user.

The term “output device” refers to a peripheral device that outputs data in a tangible or external form, such as a printer, and that receives print data from the processor to produce printed media.

The term “print data” refers to formatted data, such as page layout information and text, generated by the processor to be sent to an output device for physical printing.

The term “real-time dialog” refers to an interaction mode in which the processor repeatedly processes inputs and provides outputs with sufficiently low latency such that a user can use the system during ongoing spoken or interactive communication.

The term “generation processing by the generative AI model” refers to an operation in which the generative AI model receives a prompt sentence and produces response information including expected questions and answer examples.

The term “successively updated questions, answer examples, and feedback information” refers to questions, answer examples, and feedback information that are repeatedly regenerated or modified by the processor during a real-time dialog as new input and emotion information become available.

The term “rule-based processing” refers to processing in which the processor applies predefined logical or heuristic rules, independent of the generative AI model, to generate or adjust answer examples or feedback information.

The term “similar information materials” refers to stored documents, presentations, or other information materials in the information set that are determined by the processor to be related to new user-provided information based on important terms and context information.

The term “reaction records” refers to stored data describing how recipients responded to past questions and answers, including behavior logs, ratings, or qualitative feedback.

The term “evaluation information” refers to data that indicates quality, effectiveness, or relevance of past questions and answers or interactions, such as scores, labels, or assessment results.

The term “generation accuracy” refers to a measure of how relevant, precise, and appropriate the generated questions and answer examples are with respect to the received information, past information, and context information.

The term “search of the similar cases” refers to a retrieval process in which the processor compares important terms and context information against stored data in the information set to identify records representing situations analogous to a current situation.

In one embodiment, a server cooperates with at least one terminal to implement the claimed system. The server comprises at least one processor, a main memory, a non-volatile storage device, and a network interface. The terminal comprises a processing unit, a display device, an audio input device, an image input device, and optionally a printing device or a communication path to a printing device. The server and the terminal communicate via a communication network using a defined communication protocol such as HTTP over TCP/IP.

The server executes server-side application software running on an operating system. The server-side application software is implemented, for example, in a high-level programming language and uses libraries and frameworks for natural language processing, speech recognition client control, emotion recognition client control, database access, and generative AI model access. The server stores past information and session information in a structured data store such as a relational database or a key-value store.

The terminal executes terminal-side application software that provides a user interface, controls the display device, acquires voice information through a microphone, acquires image information through a camera, and transmits these data to the server. The terminal may be a portable device, a wearable device, a desktop device, or a combination of such devices. The terminal-side software may be implemented as a web client application running in a browser environment or as a native application.

The server stores past information in a structured format. The server represents each past question-and-answer record as a record structure including at least: an identifier, a question text, an answer text, topic tags, extracted important terms, and reaction information. The server stores reaction information as numerical scores, categorical labels, or time-series logs indicating recipient reactions. The server also stores information materials as records including an identifier, a document content field, and metadata fields such as domain category, product category, or presentation type. The server indexes these records using a combination of full-text indexes and term-based indexes to enable efficient retrieval during similar-case search.

The server executes a natural language processing module on the received information and past information. The server applies tokenization, sentence segmentation, part-of-speech tagging, and named-entity recognition to the text. The server uses a numerical representation of text, such as term frequency-inverse document frequency vectors or word-embedding vectors, to compute importance scores for terms. The server constructs a data structure representing context information, which may be implemented as an object or record containing a list of important terms, topic labels, and links to related past records. The server maintains this context information in memory for use during prompt sentence generation and similar-case search.

The server implements a similar-case search module. The server computes a similarity score between the current context information and each candidate past record. The server may compute similarity using cosine similarity between term vectors, distance metrics on embedding vectors, or hybrid metrics that combine term overlap and topic similarity. The server selects a subset of past records as similar cases, based on a similarity threshold or by selecting top-ranked candidates. The server then extracts representative pairs of questions and answers from these similar cases. The server may compress or cluster the selected pairs to avoid redundancy, using clustering algorithms that group similar questions and choose a representative question within each group.

The server constructs a prompt sentence for a generative AI model by combining the context information and the representative question-and-answer pairs. The server encodes the context information into natural language, for example by generating a summary sentence of the information materials, enumerating important terms, and appending a set of example questions and answers. The server appends an explicit instruction for the generative AI model. The prompt sentence is a continuous sequence of characters suitable for input to the generative AI model.

In one example, the server generates a prompt sentence as follows:

“Presentation material: New product launch with focus on target market and pricing. Extracted keywords: market entry, price strategy, target segment. Past Q&A examples: Q1: ‘What are the main risks associated with entering this new market?’ A1: ‘The main risks include uncertainty about customer acceptance, potential competitive responses, and regulatory changes.’ Q2: ‘How did you determine the price strategy?’ A2: ‘We analyzed competitor prices, customer willingness to pay, and cost structure.’ Based on this information, generate 10 likely questions and clear, concise answer examples suitable for a business presentation.”

In another example, the server incorporates emotion-related instructions and generates a prompt sentence:

“The presenter is anxious about unexpected questions. Presentation material: A new smartphone with a high-performance battery and advanced camera. Extracted keywords: battery life, camera function, main features. Past Q&A examples: Q1: ‘How long does the battery last?’ A1: ‘It lasts up to 24 hours of typical use.’ Q2: ‘What is special about the camera?’ A2: ‘It offers optical image stabilization and night mode.’ Based on this information, generate likely customer questions and detailed, step-by-step answer examples that are easy to understand for an anxious presenter.”

The server transmits the generated prompt sentence to a generative AI model. The server accesses the generative AI model via an application programming interface. The generative AI model may be implemented as a neural network-based language model trained on large-scale text corpora. The server may store the generative AI model locally or access it as a remote service.

In one embodiment, the generative AI model is a transformer-based neural network including an input embedding layer, multiple self-attention layers, feed-forward layers, and an output projection layer. The model receives the prompt sentence tokenized into subword units and maps each token to an embedding vector. The model applies multi-head self-attention to capture dependencies between tokens and applies layer normalization and residual connections to stabilize training and inference. The model computes output logits for each next-token position and uses a decoding algorithm such as greedy decoding or beam search to generate an output sequence representing response information.

The server configures the generative AI model with parameters such as a temperature value, a maximum number of tokens to generate, and a top-k or top-p sampling configuration. The server chooses these parameters to balance diversity and stability of generated questions and answers. The server may adjust these parameters based on emotion state, for example selecting lower temperature when the user is anxious to obtain more deterministic answers.

The server obtains the response information from the generative AI model. The server parses the response information according to a predefined output format. The server separates generated questions, generated answers, and any auxiliary text. The server stores the response information as structured records in memory and optionally persists them in the database. The server may normalize text by applying standardized punctuation, capitalization, and segmentation.

The server additionally executes rule-based processing modules. In some configurations, the server generates or refines answer examples and feedback information without requesting additional text from the generative AI model. The server applies predefined rules that map emotion states, topic labels, and question types to specific textual templates or adjustment operations. For example, when the emotion recognition module estimates an anxious state, the server inserts introductory phrases such as “First,” “Next,” and “Finally” and expands answers into numbered steps, following rule definitions stored in a rule set.

The server processes voice information and image information transmitted from the terminal to estimate an emotional state. The server sends voice information to a speech recognition engine to obtain character information. The server may use this character information not only for question recognition but also to analyze the user's language patterns, such as frequency of hesitation words, which may be used as features for emotion recognition. The server also sends image information, such as frames of the user's face, to an emotion analysis module. The emotion analysis module may be a trained classifier that receives facial landmark features, action unit activations, or pixel-level embeddings and outputs an estimated emotion label and intensity scores.

The server implements the emotion recognition module as a separate neural network, such as a convolutional neural network for images and a recurrent or transformer-based network for sequences of speech features. The server extracts input features such as mel-frequency cepstral coefficients or spectral features from audio signals, and uses them as input to the audio-based emotion classifier. The server fuses outputs of the image-based classifier and audio-based classifier, for example using weighted averaging or another fusion algorithm, to compute a final emotional state score. The server stores this emotional state as part of a session state structure.

The server uses the emotional state when generating or adjusting prompt sentences and response information. For example, when the emotional state indicates anxiety, the server modifies the prompt sentence to explicitly instruct the generative AI model to generate detailed and step-by-step answers. Alternatively, the server performs post-processing of the generated answers, inserting additional explanation segments or emphasizing reassuring language according to rule definitions. This configuration leads to a change in the internal behavior of the generative AI model and the overall output distribution, which improves consistency, reduces variability of output across sessions, and yields responses that better match user conditions.

The server presents response information and feedback information to the terminal. The server encapsulates information into a structured data format and sends it to the terminal through the communication network. The terminal receives the structured data and renders it on the display device. The terminal arranges questions and answer examples in a user interface adapted for the device form factor. For example, the terminal may display short question summaries with expandable sections for full answers, or may overlay concise answer hints over a main view in the case of a wearable display.

The terminal may present feedback information in a separate region or as short notifications visible only to the user. The terminal may distinguish between content to be conveyed to another person, such as a customer, and content intended only as coaching information for the user. The terminal may apply distinct visual styles to these categories to prevent confusion.

The terminal also may output print data to a printing device. The server or the terminal arranges the generated questions, answer examples, and feedback information into a printable layout that includes section headers, numbered lists, and example scenarios. The terminal then transmits the print data to a printing device, and the printing device produces a physical document. The physical document can be used by the user for offline rehearsal or as reference material during a presentation.

The server improves internal computer operation relative to conventional systems in several ways. The server constructs context information and prompt sentences using structured representations and similar-case retrieval, thereby reducing the number of calls to the generative AI model needed to achieve stable and relevant outputs. Because the prompt sentence incorporates representative examples and context, the generative AI model can converge more quickly to appropriate responses in a single inference, which reduces computation load, inference time, and network bandwidth associated with repeated model calls.

The server integrates speech recognition and text processing into a single pipeline. The server converts voice information to character information and then processes it using the same natural language processing components as text input. This unification reduces duplication of code, allows reuse of internal caches of term vectors, and achieves consistent behavior between speech-based and text-based interactions. The server thus increases processing throughput per hardware resource and reduces memory consumption by sharing data structures for both input modes.

The server uses emotion recognition to adjust prompt sentences and responses as a technical parameter. This adjustment affects not only user-perceived style but also internal algorithmic choices such as sampling parameters and rule-based expansion strategies. As a result, the system reduces variance in generative output probability distributions, lowers the rate of incoherent or incomplete answers, and improves convergence of the model's decoding process. This leads to improved computation efficiency compared to a system that does not control the model using such emotion-based signals.

The server organizes data in specific data structures and follows a defined processing architecture. The server maintains a session-level structure including fields for current important terms, context information, similar-case identifiers, emotional state, and the latest generated questions and answers. The server updates this structure incrementally as new inputs arrive. This incremental update strategy reduces the need to recompute features from scratch and thus reduces computation time and processor usage. The server may maintain caches of embeddings or term vectors to accelerate repeated retrieval of similar cases.

The server and terminal cooperate to achieve technical improvements in real-time dialog scenarios. Because the server repeats speech recognition, natural language processing, generative AI model inference, and emotion recognition with low-latency paths, the terminal can present updated content within a time window acceptable for live discussions. The system thereby transforms the terminal's display device into an adaptive assistance interface that responds to user state and context, going beyond simple static display and enabling dynamic control of presentation content.

The user operates the terminal to supply information materials and to consume generated questions, answers, and feedback. The user may upload a presentation document and then view automatically produced expected questions and model answers. The user may further rehearse by reading the generated answers while the terminal and server monitor the user's emotion state and adjust subsequent generations. This interaction pattern is enabled by the described data structures, processing modules, and model-driven operations and does not correspond merely to automating manual drafting of questions; instead, it leverages the computational architecture to improve stability, speed, and precision of question-and-answer generation that would not be achievable by a human-only process.

In alternative embodiments, the server may use different architectures for the generative AI model and emotion recognition model. The server may use a recurrent neural network-based sequence model instead of a transformer-based model, or may use hybrid models that combine rule-based components with generative neural models. The server may add or remove certain modules, such as using a local speech recognition engine instead of a remote service, or using a different feature extraction stage for emotion recognition. The essential configuration remains that the server uses context information derived from user-provided information and past information, uses similar-case retrieval to select representative examples, constructs and adjusts prompt sentences based on this information and emotional state, and uses a generative AI model to generate questions and answers that are presented by the terminal.

The terminal may also vary in form and capability. The terminal may be a head-mounted display device, a handheld device, a desktop display, or a combination thereof. The terminal may support multi-modal input, such as touch input, voice commands, and gesture recognition. The server may adapt its output format to the capabilities of the terminal, for example by shortening answers when a limited display area is available.

Through these embodiments and variations, the server and terminal achieve a technical effect of improving the performance and functionality of a computer-implemented question-and-answer support system. The improvements include increased processing speed through reuse of shared components and incremental updates, improved accuracy in question and answer generation through structured context and similar-case use, reduced computational burden on the generative AI model by effective prompt construction, and reduced communication load by limiting multiple model calls. Additionally, the use of emotion recognition as a control signal enables the system to adaptively tune generation behavior and resource allocation, resulting in a more efficient and technically enhanced computer system.

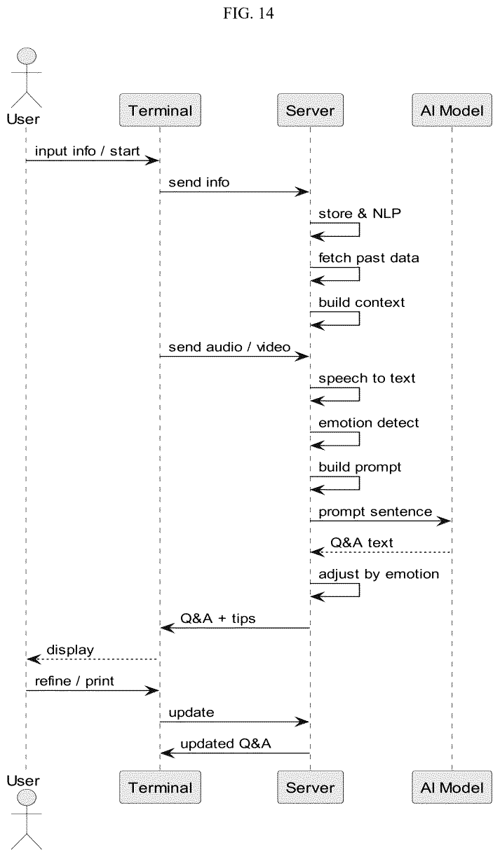

The following describes the processing flow using FIG. 14.

### Step 1

User operates the terminal to provide information.

User selects or uploads information materials such as presentation documents, product descriptions, or topic descriptions through the terminal's user interface. The input to this step is raw user content in the form of text, files, or topic selections. The output of this step is a request message containing the user content and metadata, which the terminal prepares for transmission.

### Step 2

Terminal transmits user information to the server.

Terminal packages the uploaded files and typed text into a structured request, for example using an HTTP POST with multipart or JSON content. The input is the user content and associated metadata stored in the terminal's memory. The terminal performs data serialization and communication protocol handling to send this request to the server. The output is a network message delivered to the server containing the user information.

### Step 3

Server stores and normalizes received information.

Server receives the network message and parses the payload to extract the user content and metadata. The input is the serialized request from the terminal. The server converts document formats into plain text if needed, assigns internal identifiers, and writes the content and metadata into database tables or other structured storage. The output is a set of stored records representing the current session, including references to the uploaded information materials.

### Step 4

Server retrieves relevant past information.

Server analyzes the metadata (for example, domain category or topic) and constructs database queries to obtain past records of questions, answers, and related information. The input is the session identifier and metadata stored in the database. The server executes queries and loads matching records into memory, performing basic filtering by date, category, or relevance scores. The output is a collection of past information records that will be used in later processing.

### Step 5

Server performs natural language processing on user information and past information.

Server applies tokenization, sentence segmentation, part-of-speech tagging, and entity recognition to the text of the user information and selected past information. The input is plain text strings retrieved from storage. The server computes term frequencies, inverse document frequencies, and possibly embedding vectors to quantify term importance and semantic similarity. The output is a structured context representation containing important terms, topic labels, and links to related past records for the current session.

### Step 6

Server performs similar-case search using extracted context.

Server computes similarity scores between the current context representation and candidate past records using metrics such as cosine similarity on term vectors or other distance functions. The input is the context representation from Step 5 and a candidate set of past records from Step 4. The server sorts or filters the candidates to select similar cases, then extracts representative question-and-answer pairs and their associated reaction and evaluation data. The output is a set of representative pairs of questions and answers and associated context, stored in memory for use in prompt construction.

### Step 7

Server constructs an initial prompt sentence for the generative AI model.

Server synthesizes a natural language description of the user information, lists important terms, and embeds the representative question-and-answer pairs into an instruction text. The input is the context representation and the representative pairs from Step 6. The server concatenates these elements into a coherent prompt sentence that explicitly instructs the generative AI model to generate expected questions and answer examples. The output is a complete prompt sentence string associated with the current session.

### Step 8

Terminal captures voice and image information for real-time interaction (when used).

User speaks or practices responses while viewing the terminal display, and the terminal records audio and optionally video. The input is the user's voice and facial expressions captured via microphone and camera. The terminal converts audio into a digital stream, compresses audio and image data if necessary, and prepares them as payloads. The output is a set of audio and image data packets transmitted to the server for further processing.

### Step 9

Server converts voice information into character information.

Server receives audio data from the terminal and passes it to a speech recognition engine. The input is the digital audio stream from Step 8. The speech recognition engine analyzes acoustic features, matches them against language models, and outputs recognized text representing the spoken content. The server then cleans and segments this text. The output is character information (recognized text) that is ready to be processed by the same natural language pipeline used for user documents.

### Step 10

Server integrates speech-derived text into keyword extraction and similar-case search.

Server feeds the character information from Step 9 into its natural language processing module. The input is the recognized speech text and the existing context representation from Step 5. The server updates the set of important terms, recomputes or adjusts topic labels, and, if necessary, performs another similar-case search to include speech-derived content. The output is an updated context representation and optionally a refined set of representative question-and-answer pairs.

### Step 11

Server performs emotion recognition based on image and voice information.

Server receives image frames and possibly audio features from the terminal. The input is the multimedia data captured in Step 8 and optionally text produced in Step 9. The server runs an emotion recognition algorithm that extracts features such as facial landmarks, expression categories, and prosodic patterns, then classifies these into an emotional state with associated intensity values. The output is an estimated emotional state, stored as part of the session state, indicating conditions such as anxiety level or confidence level.

### Step 12

Server adjusts or augments the prompt sentence using emotional state.

Server evaluates whether the estimated emotional state meets conditions such as “anxious presenter.” The input is the initial prompt sentence from Step 7 and the emotional state from Step 11. The server may add explicit instructions like “generate step-by-step, detailed answers suitable for an anxious presenter” or modify sampling parameters for the generative AI model. The output is an emotion-aware prompt sentence and updated control parameters for the generative AI generation.

### Step 13

Server sends the prompt sentence to the generative AI model and generates response information.

Server submits the emotion-aware prompt sentence to the generative AI model via an interface. The input is the prompt sentence and configuration settings such as temperature, maximum tokens, and sampling method. The generative AI model performs internal inference to compute next-token probabilities and decodes an output sequence. The server receives the generated output and parses it into structured response information. The output is a set of expected questions, answer examples, and possibly additional generated guidance text.

### Step 14

Server applies rule-based post-processing to generated answers and feedback.

Server inspects the generated questions and answers for length, structure, and alignment with the emotional state. The input is the response information from Step 13 and the emotion state from Step 11. The server applies rule-based templates to expand or simplify answers, insert step-by-step markers, or append reassurance statements. The output is an adjusted set of answer examples and associated feedback information, tailored to the user's emotional condition and scenario.

### Step 15

Server formats response information and feedback for terminal presentation.

Server organizes the questions, answers, and feedback into structured lists and sections. The input is the processed response and feedback data from Step 14. The server assigns identifiers, groups items into categories such as “likely questions” and “support tips,” and serializes this structure into a format appropriate for the terminal, such as a JSON object. The output is a presentation-ready data package containing all information needed by the terminal UI.

### Step 16

Terminal receives formatted data and renders it on the display device.

Terminal obtains the presentation-ready data package from the server. The input is the serialized structure containing questions, answer examples, and feedback information from Step 15. The terminal parses this data, creates user interface elements, and draws them on the display device, for example as lists, cards, or overlay elements. The output is a rendered visual interface that shows user-facing answers and separate feedback messages on the display.

### Step 17

User interacts with the displayed questions, answers, and feedback.

User reads the generated content, selects particular questions to view full answers, and may mark or edit items. The input is the rendered interface and user input events such as clicks, taps, or key presses. The terminal updates local state and optionally sends modifications (for example, edits or favorites) to the server. The output is updated UI states and, when applicable, updated session data on the server reflecting the user's selections and edits.

### Step 18

Terminal generates print data upon user request.

User initiates printing from the terminal interface. The input is the current set of questions, answer examples, and feedback information displayed on the terminal. The terminal formats this content into a print layout, arranging text into pages with headings and numbered lists. The output is print data, such as a formatted document, forwarded to a printing device or print subsystem.

### Step 19

Server and terminal repeat processing in real-time dialog mode.

User continues a live dialog, and the terminal keeps capturing new voice and image inputs while the server repeatedly updates analysis and generation. The input is the ongoing multimodal data stream and prior session context. The server reuses previous context, updates important terms, re-estimates emotional state, regenerates or refines prompt sentences, and calls the generative AI model as needed. The output is a sequence of successively updated questions, answer examples, and feedback information, which the terminal continuously refreshes on the display to support the user in real time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

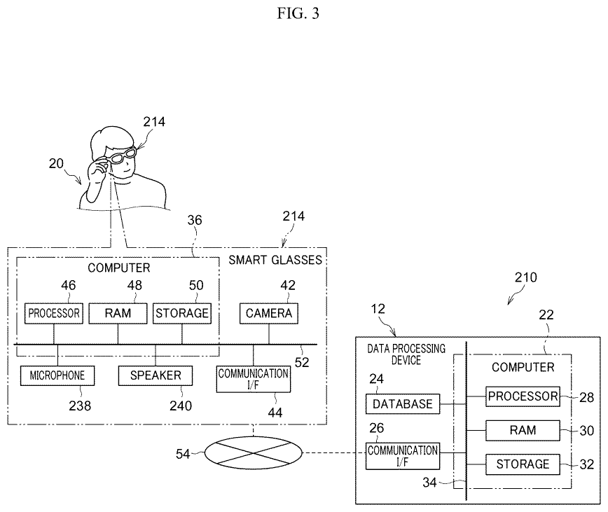

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

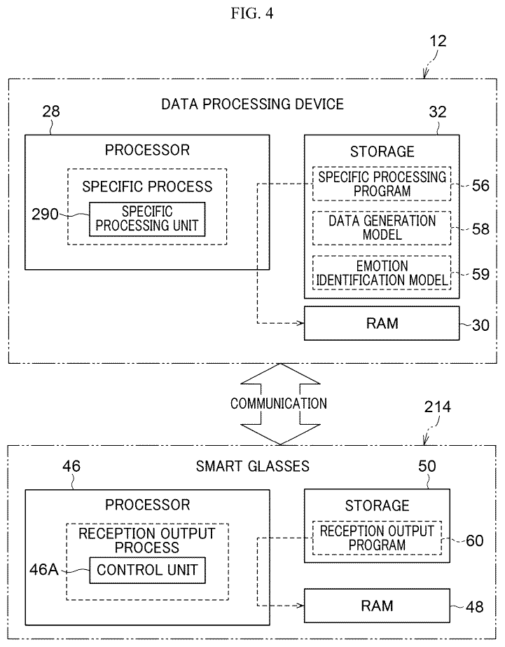

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

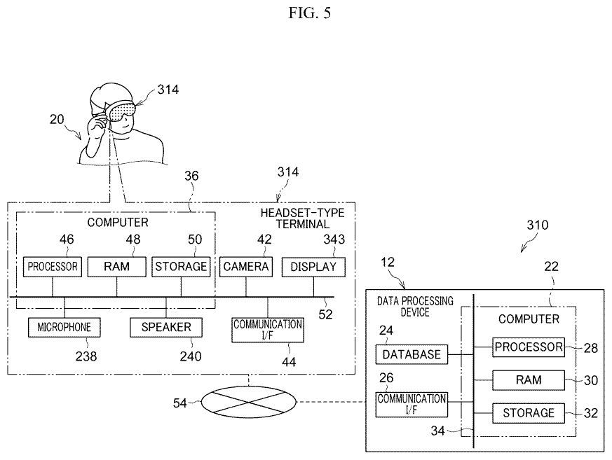

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

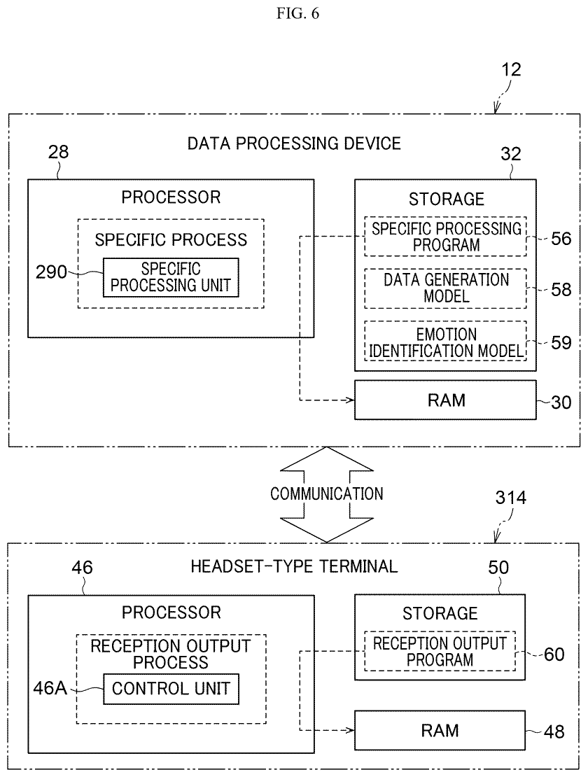

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

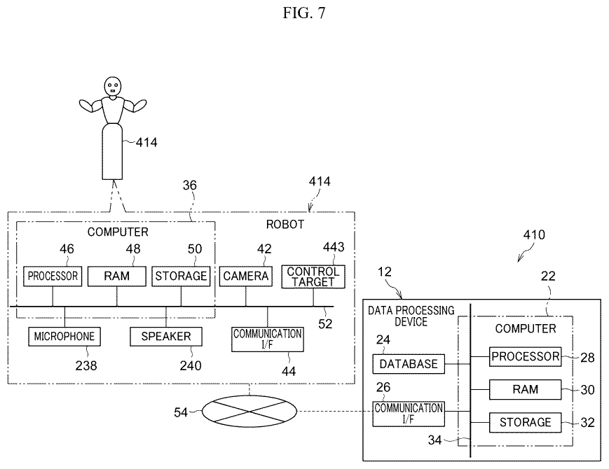

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

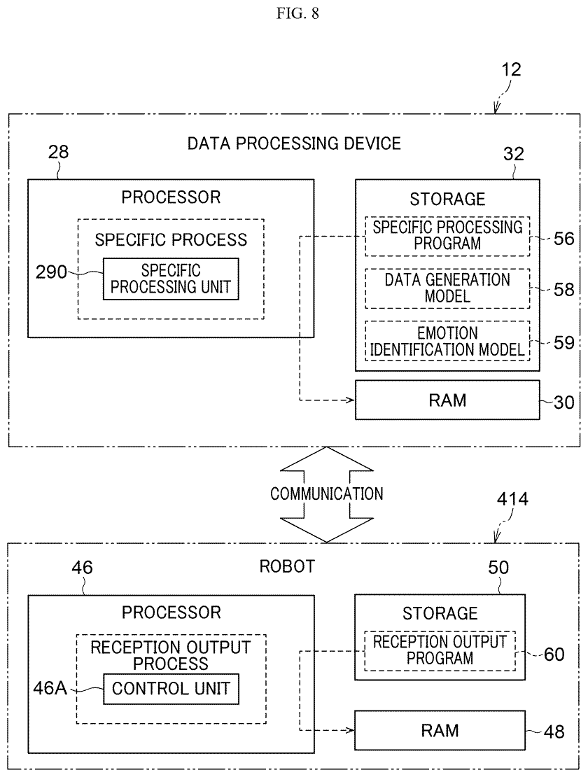

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

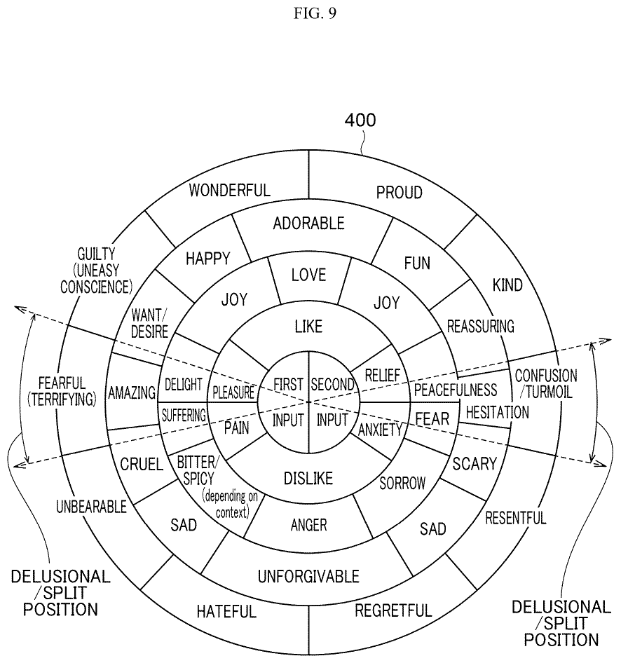

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

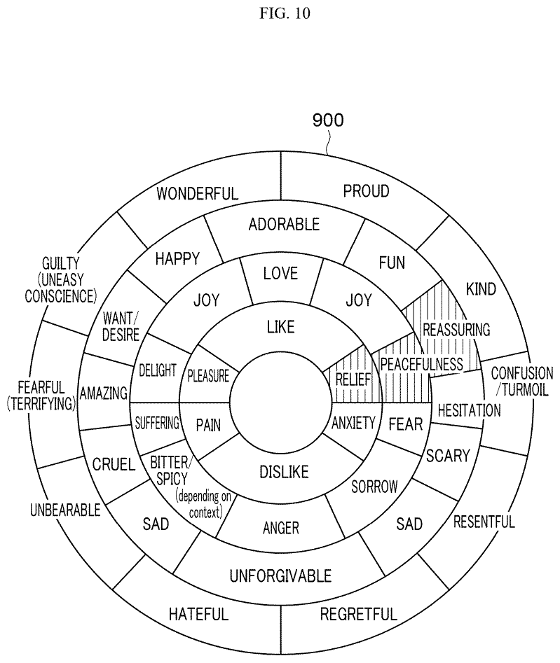

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive document information or image information from a user as input data and store the input data in a storage device,
acquire past case information including structured information and unstructured information from an information storage device,
extract character string elements from the input data and the past case information, perform preprocessing on the character string elements, and extract feature terms and important phrases by natural language processing,
generate semantic representation vectors for the input data and the past case information, calculate similarity between the semantic representation vectors, and select, based on the similarity, past case information related to the input data,
construct a prompt sentence, which is an instruction sentence to a generative AI model, based on the extracted feature terms, the important phrases, summary information of the selected past case information, and a request content supplied by the user,
transmit the constructed prompt sentence to an internal or external generative AI model via a communication network,
obtain response information generated by the generative AI model in response to the prompt sentence and divide or structure the response information into items to generate display information,
output the display information to a display device and present the display information to the user, and
record the input data, the prompt sentence, and the response information as history information and store at least a part of the history information as future past case information.

### Supplementary 2

The system according to supplementary 1,
wherein the processor is configured to
adjust the prompt sentence and the display information such that the response information, which includes proposal information, explanatory information, and cautionary information based on the input data and the past case information, contributes to reduction of psychological anxiety of the user.

### Supplementary 3

The system according to supplementary 1,
wherein the processor is configured to
use the past case information configured as a data set including similar explanatory information, question-and-answer information, and reaction information to the question-and-answer information, and extract, based on the similarity, a case related to the input data from the data set by the selection based on the similarity.

### Application Example 1

### Supplementary 1

A system comprising a processor,
wherein the processor is configured to
receive, via an input mechanism connected to an information processing apparatus, information materials from a user as input data,
acquire past case information from a stored collection of record information in a storage apparatus connected to the information processing apparatus,
extract character-based information from the information materials, perform natural language processing including tokenization, normalization of word forms, and element extraction on the character-based information, and identify key point information contained in the information materials,
perform statistical analysis or machine learning-based feature extraction on description information and result information included in the past case information, and derive success patterns that are common to successful past cases,
calculate similarity between the key point information and the success patterns, and select, based on the calculated similarity, one or more success patterns related to the information materials,
structure context information including the key point information and the selected success patterns, and generate a prompt sentence that instructs a generative AI model to generate proposal information based on the context information,
transmit the prompt sentence to the generative AI model, and obtain, as a response from the generative AI model, proposal information generated on the basis of the context information,
format the proposal information into a predetermined display format and output the formatted proposal information to a display device to present the proposal information to the user, and
receive, via the input mechanism, additional instructions or correction instructions from the user, regenerate the prompt sentence based on updated context information including the additional instructions or the correction instructions and the proposal information, and iteratively cause the generative AI model to regenerate the proposal information.

### Supplementary 2

The system according to supplementary 1,
wherein the processor is configured to treat the past case information as an information set including a plurality of case records each having at least action content, target attributes, implementation timing, used medium, evaluation indices, and numerical information regarding the evaluation indices, and to store the success patterns as structured data within the information processing apparatus, the success patterns representing combinations of elements common to groups of case records in which the evaluation indices satisfy a predetermined condition.

### Supplementary 3

The system according to supplementary 1,
wherein the processor is configured to select the success patterns based on similarity between feature vectors corresponding to the information materials and feature vectors corresponding to the past case information, and to explicitly specify, in the prompt sentence, selection results as generation conditions, thereby causing the generative AI model to generate the proposal information reflecting the past case information.

### Example 2

### Supplementary 1

A system comprising a processor,
wherein the processor is configured to
receive, from a user, an operation for selecting and transmitting a presentation material file via an information processing apparatus, and to accept the presentation material file as input data,
extract character information from the presentation material file and generate feature information by performing natural language processing on the extracted character information, including dividing the character information into word sequences and phrase sequences and assigning part-of-speech information and importance information to the word sequences and the phrase sequences,
search a stored group of past cases in an association information storage unit based on the feature information and extract past case information having high relevance according to a similarity between the feature information and each past case,
integrate the feature information and the past case information as context information in accordance with a predetermined format and generate a prompt sentence that instructs a generative AI model to generate anticipated questions and answer examples,
transmit the prompt sentence to the generative AI model and acquire, from the generative AI model, a plurality of question-and-answer candidates generated by inference processing of the generative AI model,
select, from the plurality of question-and-answer candidates, question-and-answer candidates that satisfy a predetermined criterion based on at least one of a degree of duplication, a length, and a keyword inclusion status, and format the selected question-and-answer candidates as result information in a form of structured data or a document file, and
transmit the result information to the information processing apparatus and present the result information to the user in a displayable or downloadable format.

### Supplementary 2

The system according to supplementary 1,
wherein the processor is configured to
cause the result information to include question-and-answer candidates that are configured as anticipated questions and corresponding answer examples related to the presentation material file, and are generated for a purpose of reducing psychological anxiety of a user who performs a presentation activity.

### Supplementary 3

The system according to supplementary 1,
wherein the processor is configured to
cause the group of past cases to be stored in the association information storage unit as a dataset that includes, for each case, at least presentation content information, related keyword information, question-and-answer content information, and reaction information to the question-and-answer content information.

### Application Example 2

### Supplementary 1

A system comprising a processor,
wherein the processor is configured to
receive information from a user as input,
obtain past information from an information storage device,
perform natural language processing on the received information and the obtained past information to extract important terms and to generate context information including topic information and related information,
search, on the basis of the extracted important terms and the context information, an information set including past records of questions and answers to retrieve similar cases and to obtain representative pairs of questions and answers,
generate a prompt sentence that instructs a generative AI model to generate expected questions and answer examples, the prompt sentence being generated on the basis of the context information and the obtained pairs of questions and answers,
transmit the generated prompt sentence to the generative AI model and obtain response information from the generative AI model, the response information including the expected questions and the answer examples,
convert voice information transmitted from a terminal into character information by using speech recognition processing and use the character information for the extraction of the important terms and for the search of the similar cases,
execute emotion recognition processing on the basis of image information and voice information transmitted from the terminal to estimate an emotional state of a user and, according to the estimated emotional state, adjust at least one of content and expression format of the prompt sentence or the response information,
present the obtained response information and feedback information corresponding to the emotional state to a display device of the terminal and, as needed, output print data to an output device, and
in a real-time dialog, repeatedly execute the speech recognition processing, the natural language processing, generation processing by the generative AI model, and the emotion recognition processing, and present successively updated questions, answer examples, and feedback information to the display device.

### Supplementary 2

The system according to supplementary 1,
wherein the processor is configured to, when the estimated emotional state of the user includes anxiety, generate, by the generative AI model or by rule-based processing,
answer examples including more detailed and step-by-step explanations and feedback information that promotes psychological stabilization, and adjust the response information so as to reduce psychological anxiety of the user.

### Supplementary 3

The system according to supplementary 1,
wherein the processor is configured such that the past information is stored, in the information storage device, as a data set including similar information materials, records of questions and answers, and records and evaluation information of reactions to the questions and answers, and to use the data set in the search of the similar cases to improve generation accuracy of the questions and the answer examples.

What is claimed is:

1. A system comprising:
circuitry configured to:
receive, via a communication interface coupled to a packet-switched network, input data comprising document data or image data from a terminal device, and store the input data in a storage device;
extract character string elements from the input data and from past case data retrieved from a database, perform preprocessing on the character string elements, and extract feature terms and phrase data by natural language processing;
generate semantic representation vectors for the input data and the past case data by encoding the character string elements using an embedding model, calculate similarity values between the semantic representation vectors, and select, based on the similarity values, a subset of the past case data related to the input data;
construct a prompt data structure based on the feature terms, the phrase data, summary data of the selected subset of the past case data, and request data received from the terminal device, and transmit the prompt data structure to a generative neural network model via the packet-switched network;
acquire response data generated by the generative neural network model, segment the response data into a plurality of categorized items, and generate display data from the categorized items; and
transmit the display data to the terminal device via the communication interface, and store the input data, the prompt data structure, and the response data as history data in the storage device, at least a portion of the history data being indexed as future past case data in the database.

2. The system according to claim 1, wherein the circuitry is configured to generate the semantic representation vectors by passing token sequences derived from the character string elements through a transformer-based sentence encoder that outputs a fixed-dimensional vector for each input sequence, and to calculate the similarity values by computing cosine similarity between the semantic representation vectors of the input data and the semantic representation vectors of each entry in the past case data.

3. The system according to claim 2, wherein the circuitry is configured to rank entries in the past case data according to the similarity values and to select entries exceeding a predetermined similarity threshold or within a top-N range as the subset of the past case data.

4. The system according to claim 3, wherein the circuitry is configured to generate summary data for each entry in the selected subset by applying an extractive summarization algorithm that selects sentences from the entry based on term frequency scores and positional information.

5. The system according to claim 1, wherein the circuitry is configured to segment the response data by detecting structural markers in the response data and classifying segments into proposal data, explanatory data, and cautionary data based on linguistic pattern matching applied to each segment.

6. The system according to claim 5, wherein the circuitry is configured to classify a segment as proposal data when the segment contains modal expressions indicating a recommended action, classify a segment as explanatory data when the segment contains causal connective expressions, and classify a segment as cautionary data when the segment contains risk-indicator expressions.

7. The system according to claim 1, wherein the circuitry is configured to construct the prompt data structure by inserting the feature terms and the phrase data into a template data structure comprising a context section, a key-concept section, and a past-case section, and concatenating the sections into a single instruction text for the generative neural network model.

8. The system according to claim 7, wherein the circuitry is configured to receive additional instruction data or correction instruction data from the terminal device, update context data maintained in the storage device to include the additional instruction data or the correction instruction data together with previously generated response data, regenerate the prompt data structure based on the updated context data, and iteratively transmit the regenerated prompt data structure to the generative neural network model to acquire revised response data.

9. The system according to claim 1, wherein the circuitry is configured to estimate an emotional state of a user associated with the terminal device by applying an emotion estimation model to at least one of voice data, facial image data, or text data received from the terminal device, and to modify the prompt data structure based on the estimated emotional state by appending expression-style instruction data specifying a tone and a level of detail for the response data.

10. The system according to claim 9, wherein the circuitry is configured to adjust a sampling temperature parameter and a maximum token count parameter for the generative neural network model based on the estimated emotional state, selecting a lower sampling temperature when the estimated emotional state indicates an anxiety classification.

11. The system according to claim 1, wherein the circuitry is configured to extract the feature terms by computing term frequency and inverse document frequency values for tokens derived from the character string elements, filtering the tokens based on part-of-speech tags and a stopword list, and selecting tokens and n-grams having scores exceeding a predetermined importance threshold.

12. The system according to claim 11, wherein the circuitry is configured to extract the phrase data by identifying noun phrases and verb-object phrases from syntactic parse results of the character string elements, and weighting the identified phrases based on positional occurrence within the input data.

13. The system according to claim 1, wherein the circuitry is configured to convert voice data received from the terminal device into character data by speech recognition processing, and to process the character data through the same natural language processing used for the input data to update the feature terms and perform additional similarity-based selection of past case data.

14. The system according to claim 13, wherein the circuitry is configured to repeatedly execute the speech recognition processing, the natural language processing, prompt data structure generation, and transmission to the generative neural network model during a real-time dialogue session, and to present successively updated response data to the terminal device.

15. The system according to claim 1, wherein the past case data comprises a plurality of records, each record comprising at least a case identifier, description data, question-and-answer data, reaction data indicating user feedback, and precomputed semantic representation vectors stored in the database.

16. The system according to claim 15, wherein the circuitry is configured to prioritize records in the past case data having reaction data indicating a favorable outcome when selecting the subset of the past case data, by weighting the similarity values with a reaction score derived from the reaction data.

17. The system according to claim 1, wherein the circuitry is configured to receive a presentation material file as the input data, extract character information from the presentation material file by format-specific parsing, generate feature information comprising word sequences, phrase sequences, and importance scores, and use the feature information for the similarity-based selection of past case data comprising presentation content data, keyword data, and question-and-answer content data.

18. A system comprising:
circuitry configured to:
receive, via a communication interface coupled to a packet-switched network, input data from a terminal device and store the input data in a storage device;
extract feature data from the input data and from past case data retrieved from a database by natural language processing comprising tokenization and importance scoring;
generate semantic representation vectors for the input data and the past case data, compute similarity values between the semantic representation vectors, and select a subset of the past case data based on the similarity values;
construct a prompt data structure comprising the feature data and summary data of the selected subset, and transmit the prompt data structure to a generative neural network model via the packet-switched network;
acquire response data from the generative neural network model, segment the response data into categorized items, and transmit display data derived from the categorized items to the terminal device via the communication interface; and
store the input data, the prompt data structure, and the response data as history data, at least a portion of the history data being designated as future past case data in the database.

19. The system according to claim 18, wherein the circuitry is configured to estimate an emotional state of a user by applying an emotion estimation model to multimodal data received from the terminal device, and to modify the prompt data structure by appending expression-style parameters based on the estimated emotional state.

20. A method performed by circuitry, the method comprising:
receiving, via a communication interface coupled to a packet-switched network, input data from a terminal device and storing the input data in a storage device;
extracting character string elements from the input data and from past case data retrieved from a database, and extracting feature terms and phrase data by natural language processing;
generating semantic representation vectors for the input data and the past case data, calculating similarity values between the semantic representation vectors, and selecting a subset of the past case data based on the similarity values;
constructing a prompt data structure based on the feature terms, the phrase data, and summary data of the selected subset, and transmitting the prompt data structure to a generative neural network model via the packet-switched network;
acquiring response data from the generative neural network model, segmenting the response data into categorized items, and transmitting display data derived from the categorized items to the terminal device via the communication interface; and
storing the input data, the prompt data structure, and the response data as history data in the storage device, at least a portion of the history data being indexed as future past case data in the database.
